(19) United States
(12) Patent Application Publication
(10) Pub. No.: US 2012/0159098 A1
(43) Pub. Date: Jun. 21, 2012

(54) GARBAGE COLLECTION AND HOTSPOTS RELIEF FOR A DATA DEDUPLICATION CHUNK STORE

(75) Inventors: Chun Ho (Ian) Cheung, Bellevue, WA (US); Paul Adrian Oltean, Redmond, WA (US); James Robert Benton, Seattle, WA (US)

(73) Assignee: MICROSOFT CORPORATION, Redmond, WA (US)

(21) Appl. No.: 12/971,694

(22) Filed: Dec. 17, 2010

(51) Int. Cl. G06F 12/02; G06F 12/16

(52) U.S. Cl. 711/162; 711/170; 711/E12.002; 711/E12.103

(57) ABSTRACT

Techniques for garbage collecting unused data chunks in storage are provided. According to one implementation, data chunks stored in a chunk container that are unused are identified based an analysis of one or more stream map chunks indicated as deleted. The identified data chunks are indicated as deleted. The storage space in the chunk container filled by the data chunks indicated as deleted may then be reclaimed. Techniques for selectively backing up data chunks are also provided. According to one implementation, a data chunk is received for storing in a chunk container. A backup copy of the received data chunk is stored in a backup container if the received data chunk is in a predetermined top percentage of most referenced data chunks in the chunk container and has a number of references greater than a predetermined reference threshold.

### BACKGROUND

Data deduplication, also known as data optimization, is the act of reducing the physical amount of bytes of data which need to be stored on disk or transmitted across a network without compromising the fidelity or integrity of the original data. Data deduplication reduces the storage capacity needed to store data, and may therefore lead to savings in terms of storage hardware costs and data management costs. Data deduplication provides a solution to handling the rapid growth of digitally stored data.

Data deduplication may be performed according to one or more techniques to eliminate redundancy within and between persistently stored files. For instance, according to one technique, unique regions of data that appear multiple times in one or more files may be identified, and a single copy of those identified unique regions of data may be physically stored. References to those identified unique regions of data (also referred to as data “chunks”) may be stored that indicate the files, and the locations in the files, that include them. This technique is commonly referred to as single instancing. Compression of data may be performed in addition to single instancing. Other data reduction techniques may also be implemented as part of a data deduplication solution.

Difficulties exist in managing data stored according to data de-duplication techniques. For example, due the data fragmentation imposed by data de-duplication, latency may exist in accessing files stored according to de-duplication. This latency limits the adoption of data deduplication solutions, especially on primary storage data, where users expect seamless, fast access to files. Furthermore, data deduplication algorithms may run on a dedicated appliance or on the device that stores and serves data (e.g., a file server). In the case of a file server, data deduplication may not be the primary function of the device, and thus data deduplication techniques may need to be efficient so as not to over consume device resources (e.g., memory, input/output (I/O) mechanisms, central processing unit (CPU) capacity, etc.). Still further, because the quantity of digital data is growing at a very high rate, the size of storage devices (e.g., storage disks) and the total storage capacity associated with computing devices has to grow, causing difficulties with data deduplication techniques that do not scale well with increasing amounts of storage.

Additionally, challenges exist in handling the deletion of optimized files from storage. Deletion of such files can lead to unused data corresponding to the deleted files remaining in storage. This remaining unused data takes up storage space that could otherwise be used. Challenges also exist in enabling data to be reliably stored, particularly where such data is shared by multiple files. When data is shared by a large number of files, a loss of a stored data sector may adversely impact multiple files, even thousands of files.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and computer program products are provided for garbage collecting unused data chunks in storage and for storing redundant copies of frequently used data chunks.

For instance, implementations for garbage collecting unused data chunks in storage are provided. According to an implementation, data chunks stored in a chunk container that are unused are identified based on one or more stream map chunks that are indicated as deleted. The identified data chunks are indicated as deleted. Storage space may be reclaimed in the chunk container that is filled by the data chunks indicated as deleted.

In one implementation, the unused data chunks may be identified as follows: A plurality of stream map chunks is scanned to determine any stream map chunks not indicated as deleted. Data chunk identifiers referenced by each stream map chunk indicated as not deleted are included in a data structure (e.g., a Bloom filter). The plurality of stream map chunks is scanned to determine any stream map chunks indicated as deleted. Data chunk identifiers referenced by the stream map chunks indicated as deleted that are not included in the data structure are determined and are indicated as deleted.

In one implementation, the storage space filled by the data chunks indicated as deleted may be reclaimed as follows: Each data chunk not indicated as deleted in the chunk container is copied to a new container file. A redirection table of the new container file is populated to map the unique identifiers of copied data chunks to the starting offset for the data chunks in the new container file. The chunk container is then deleted, and the new container file may be renamed to the file name of the chunk container to replace the chunk container as a compacted version of the chunk container.

Implementations for data backup in a chunk store are provided. According to an implementation, a data chunk is received for storing in a chunk container. Whether the received data chunk is a “hotspot,” and is not already replicated for backup is determined. A “hotspot” data chunk may be defined as being included in a predetermined top percentage of most referenced data chunks in the chunk store, has a number of references greater than a predetermined reference threshold, or both. A backup copy of the received data chunk is stored in a backup container if the received data chunk is a hotspot, and is not already replicated for backup.

In one implementation, the storing of the backup copy of the received data chunk may be performed as follows. Whether the received data chunk is a duplicate of a data chunk stored in the chunk store is determined. If the received data chunk is determined to be a duplicate, whether the received data chunk has an entry in a reference count table is determined. If the received data chunk is determined to be a duplicate and to have an entry in the reference count table, a reference count value in the entry for the received data chunk in the reference count table is increased. If the received data chunk is determined to be a duplicate and to not have an entry in the reference count table, an entry is added for the received data chunk to the reference count table that includes a data chunk identifier for the received data chunk, a reference count value for the received data chunk that is a sum of an initial reference count value and an expected count value, an indication that the reference count value for the received data chunk is not an exact value, and an indication that the received data chunk is not replicated in a backup container. If the received data chunk is determined to not be a duplicate, an entry for the received data chunk is added to the reference count table. The added entry includes a data chunk identifier for the received data chunk, an initial reference count value for the received data chunk, an indication that the reference count value for the received data chunk is an exact value, and an indication that the received data chunk is not replicated in the backup container.

If the received data chunk was determined to be a duplicate, whether the received data chunk is replicated in the backup container is determined. If the received data chunk is determined to not be replicated in the backup container, the received data chunk may be designated for replication in the backup container based on an analysis of the reference count table. The received data chunk may be designated for replication if it is determined that the received data chunk has a reference count value that is greater than a minimum reference count value for already replicated data chunks, and/or that the reference count value of the received data chunk is greater than a predetermined threshold.

If the received data chunk is determined to not be replicated in the backup container, and is designated for replication in the backup container based on the analysis of the reference count table, a backup copy of the received data chunk is stored in the backup container, and the entry in the reference count table for the received data chunk is modified to include an indication that the received data chunk is replicated in the backup container.

The reference count table may be determined to have reached a predetermined size. As a result, the reference count table may be reconsolidated to reduce the memory consumption while maintaining entries for data chunks having met the hotspot condition(s). If memory is sufficient, additional entries for data chunks which have high reference counts but haven't met the hotspot condition(s) may be retained. After reconsolidation, a backup copy of data chunks may be stored in the backup container for data chunks having entries in the reconsolidated reference count table, having met the hotspot condition(s) and that are not already present in the backup container.

Computer program products are also described herein for garbage collecting unused data chunks in storage, for storing backup copies of hotspot chunks, and for further embodiments as described herein.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a block diagram of a data deduplication system, according to an example embodiment.

FIG. 2 shows a block diagram of a chunk store, according to an example embodiment.

FIG. 3 shows a block diagram of a chunk store, according to an example embodiment.

FIG. 4 shows a block diagram of metadata included in a stream map, according to an example embodiment.

FIG. 5 shows the chunk store of FIG. 3, further indicating some data chunks that are referenced by stream maps, according to an example embodiment.

FIG. 6 shows a block diagram of a data stream store system, according to example embodiment.

FIG. 7 shows a flowchart for storing a data stream, according to an example embodiment.

FIG. 8 shows a block diagram of a metadata generator, according an example embodiment.

FIG. 9 shows a flowchart for assigning locality indicators, according to an example embodiment.

FIG. 10 shows a block diagram that illustrates an example of the storing of data streams in a data store, according to an embodiment.

FIG. 11 shows a block diagram of a chunk store interface that includes a rehydration module, according to an example embodiment.

FIG. 12 shows a block diagram of a chunk container, according to an example embodiment.

FIG. 13 shows a block diagram of a data chunk identifier, according to an example embodiment.

FIG. 14 shows the example of FIG. 10, where data streams are stored in a data store, and further illustrates the effect of the removal of data chunks from the data store, according to an embodiment.

FIG. 15 shows a block diagram of a redirection table, according to an example embodiment.

FIG. 16 shows a flowchart for storing a data stream, according to an example embodiment.

FIG. 17 shows a block diagram of a data chunk redirection system, according to an example embodiment.

FIG. 18 shows a flowchart for locating data chunks in a chunk container, according to an example embodiment.

FIG. 19 shows a block diagram of a rehydration module that accesses a chunk store to rehydrate a data stream, according to an example embodiment.

FIG. 20 shows a flowchart for performing garbage collection for a chunk container, according to an example embodiment.

FIG. 21 shows a flowchart providing a process for identifying and indicating data chunks for deletion, according to an example embodiment.

FIG. 22 shows a flowchart providing a process for reclaiming storage space filled by the data chunks indicated for deletion, according to an example embodiment.

FIG. 23 shows a block diagram of a garbage collection module that communicates with a stream container and a chunk container to reclaim storage space filled by deleted data chunks, according to an example embodiment.

FIG. 24 shows a block diagram example of data chunks being copied from an old chunk container to a new chunk container, according to an embodiment.

FIG. 25 shows a flowchart for storing backup copies of data chunks stored in a chunk container, according to an example embodiment.

FIGS. 26A and 26B show an example of the process of FIG. 25, according to an embodiment.

FIG. 27 shows a block diagram of a backup storage module that communicates with a stream container, a chunk container, and a backup container to backup frequently referenced data chunks, according to an example embodiment.

FIG. 28 shows a flowchart providing a process for reconsolidating a reference count table, according to an example embodiment.

FIG. 29 shows a flowchart providing an example of the reconsolidating process of FIG. 28, according to an example embodiment.

FIG. 30 shows a block diagram of an example computer that may be used to implement embodiments of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Optimized data in this specification refers to data that has been optimized, or deduplicated, by one or more of data deduplication techniques such as single-instancing of chunks and compression. Optimized streams refer to streams that were deduplicated, or in other words, their data was optimized using data deduplication techniques.

### II. Example Embodiments

Embodiments provide techniques for data deduplication. Such embodiments enable the amount of data (e.g., number of bytes) to be stored, or to be transmitted, to be reduced without compromising the fidelity or integrity of the data. For instance, embodiments enable reductions in the amount of latency in accessing optimized data. Furthermore, embodiments enable resources, such as computing machines/devices, to be used more efficiently, reducing resource consumption. Still further, embodiments provide techniques for data deduplication, garbage collection, and the storing of backup copies of data that are scalable with the growth of the amount of digital data that is stored.

For instance, in an embodiment, a scalable chunk store is provided for data deduplication. The chunk store enables various techniques for minimizing latency in access of deduplicated data, reducing machine resource consumption (e.g., memory and disk I/O), and enhancing reliability during data deduplication, rehydration, garbage collection, and backing up of data. Example embodiments are described in further detail in the following subsections.

### A. Example Data Deduplication Embodiments

In embodiments, data to be stored may be optimized to reduce an amount of storage needed for the data. For instance, data streams may be stored in the form of unique data chunks. The data chunks may be referenced by maps that define the data streams. In this manner, the data streams are stored more efficiently, because multiple maps may reference the same stored data chunk, rather than the same data chunk being stored multiple times. Furthermore, the optimized data may be requested (e.g., by applications) from storage as desired. In such case, the data streams may be reassembled from the stored data chunks according to the corresponding maps.

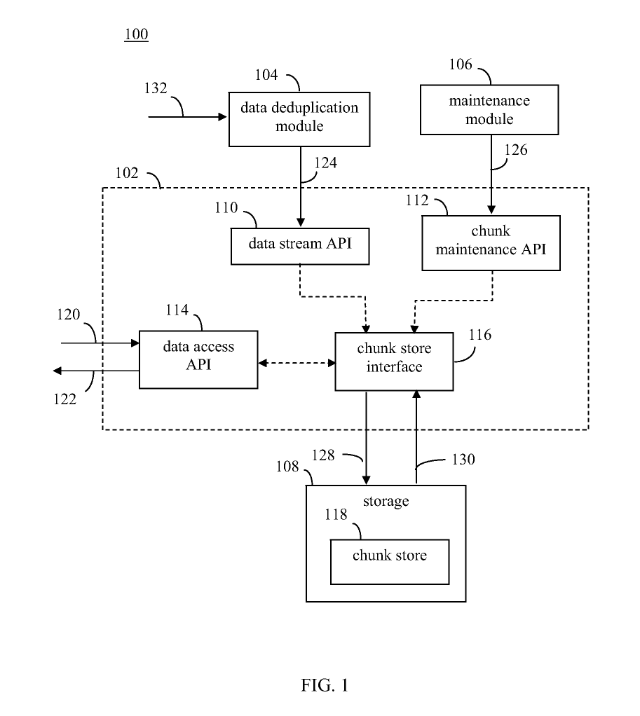

For instance, FIG. 1 shows a block diagram of a data deduplication system 100, according to an example embodiment. As shown in FIG. 1, system 100 includes a storage system 102, a data deduplication module 104, a maintenance module 106, and storage 108. Furthermore, storage system 102 includes a data stream API (application programming interface) 110, a chunk maintenance API 112, and a data access API 114. System 100 is described as follows to illustrate the storage of optimized data, and the recovery of optimized data from storage, and is not intended to be limiting.

System 100 is configured to enable data to be stored in storage 108 in an efficient manner, and for data to be retrieved from storage 108. For example, in an embodiment, data deduplication module 104 may be present. Data deduplication module 104 is configured to optimize received data for storage. For instance, data deduplication module 104 may segment and compress received data received as a data stream 132. Data stream 132 may include a portion of a data file, a single data file, multiple data files, and/or any combination of files and/or file portions. As shown in FIG. 1, data deduplication module 104 generates data chunks 124, which may be a compressed and segmented version of data stream 132.

Data stream API 110 provides an interface for storage system 102 to receive data chunks 124. Data chunks 124 may include a plurality of data chunks that form data stream 132 from which data chunks 124 are generated. Data stream API 110 may be configured in any suitable manner, as would be known to persons skilled in the relevant art(s). Data stream API 110 may output data chunks 124 to be received by chunk store interface 116.

As shown in FIG. 1, storage 108 is coupled to storage system 102. Chunk store interface 116 is an interface between APIs 110, 112, and 114 and storage 108. For example, chunk store interface 116 may receive data chunks 124, and may store the data chunks of data chunks 124 in storage 108. For example, as shown in FIG. 1, storage 108 includes a chunk store 118. Chunk store interface 116 may store the received data chunks of data chunks 124 in chunk store 118 as data chunks 128.

Data access API 114 provides an interface for applications to request data of storage system 102. For instance, as shown in FIG. 1, data access API 114 may receive a data stream request 120. Data access API 114 may be configured in any suitable manner, as would be known to persons skilled in the relevant art(s). Data access API 114 may output data stream request 120 to be received by chunk store interface 116. Chunk store interface 116 may request the data chunks from storage 108 (e.g., from chunk store 118) that correspond to the requested data stream of data stream request 120. Chunk store interface 116 may receive the requested data chunks from storage 108 as data chunks 130, and may provide a data stream that includes data chunks 130 to data access API 114. Data access API 114 may provide the data stream (e.g., one or re-assembled files) to the requesting application as data stream response 122.

Furthermore, maintenance module 106 may be present to perform one or more types of maintenance jobs with respect to data chunks stored in chunk store 118. For example, maintenance module 106 may include a defragmentation module to perform defragmentation of data chunks stored in storage 108. For instance, the defragmentation module may be configured to eliminate empty spaces in storage 108, to move related data chunks into a sequence, and/or to perform other related tasks. In another example, maintenance module 106 may include a garbage collection module to perform garbage collection of data chunks stored in storage 108. For instance, the garbage collection module may be configured to delete unused data chunks in storage 108 (e.g., perform compaction). In further embodiments, maintenance module 106 may perform additional or alternative maintenance tasks with respect to storage 108.

As shown in FIG. 1, chunk maintenance API 112 provides an interface for maintenance module 106 to interact with storage system 102. Maintenance module 106 may generate a maintenance task 126 (e.g., a defragmentation instruction, a compaction instruction, a data chunk deletion instruction, etc.) that is received by chunk maintenance API 112. Chunk maintenance API 112 may be configured in any suitable manner, as would be known to persons skilled in the relevant art(s). Chunk maintenance API 112 may provide maintenance task 126 to chunk store interface 116. Chunk store interface 116 may enable maintenance task 126 to be performed on data chunks stored in storage 108.

Storage system 102 may be implemented in any suitable form, including the form of one or more computers/computing devices, etc. Storage 108 may include one or more of any type of storage mechanism, including a magnetic disc (e.g., in a hard disk drive), an optical disc (e.g., in an optical disk drive), a magnetic tape (e.g., in a tape drive), one or more memory devices (e.g., Flash memory, a solid-state drive (SSD), etc.) and/or any other suitable type of storage medium.

Note that data deduplication system 100 is example of an environment in which embodiments of the present invention may be implemented. Data deduplication system 100 is provided for purposes of illustration, and is not intended to be limiting. Embodiments may be incorporated in further types and configurations of data deduplication systems.

### B. Example Chunk Store Embodiments that Enable Data Chunk Locality

Chunk store 118 of FIG. 1 may store data streams in the form of data chunks in any manner. For instance, chunk store 118 may store maps that indicate the data chunks included in the data streams, and may store the referenced data chunks. In an embodiment, chunk store 118 does not store duplicate copies of data chunks, according to data de-duplication techniques.

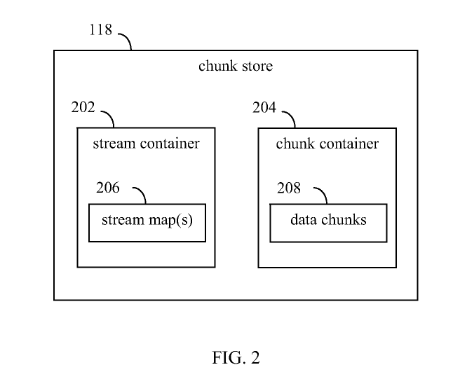

For instance, FIG. 2 shows a block diagram of chunk store 118, according to an example embodiment. As shown in FIG. 2, chunk store 118 includes a stream container 202 and a chunk container 204. Stream container 202 includes one or more stream maps 206, and chunk container 204 includes a plurality of data chunks 208. Although shown in FIG. 2 as including a single stream container 202 and chunk container 204 for ease of illustration, chunk store 118 may include any number of stream containers 202 and chunk containers 204. A data chunk 208 is a segment of data that is referenced by one or more data streams (e.g., data stream 132 of FIG. 1). A stream map 206 is a data structure that describes the mapping between the original data stream structure and the optimized data chunk structure. Stream map 206 contains data chunk location information and data chunk ordering, either directly or through an indirection layer, such that the referenced data chunks can be located and assembled into a file stream view. Data chunks 208 and stream maps 206 are stored in stream container 202 and chunk container 204, respectively, which may be files in a file system. In an embodiment, chunk store 118 stores all data in the form of chunks, such that stream maps 206 are stored as data chunks that contain internal metadata (data stream metadata) to describe the file stream-to-data chunk 208 mapping, data chunk addresses, and hashes.

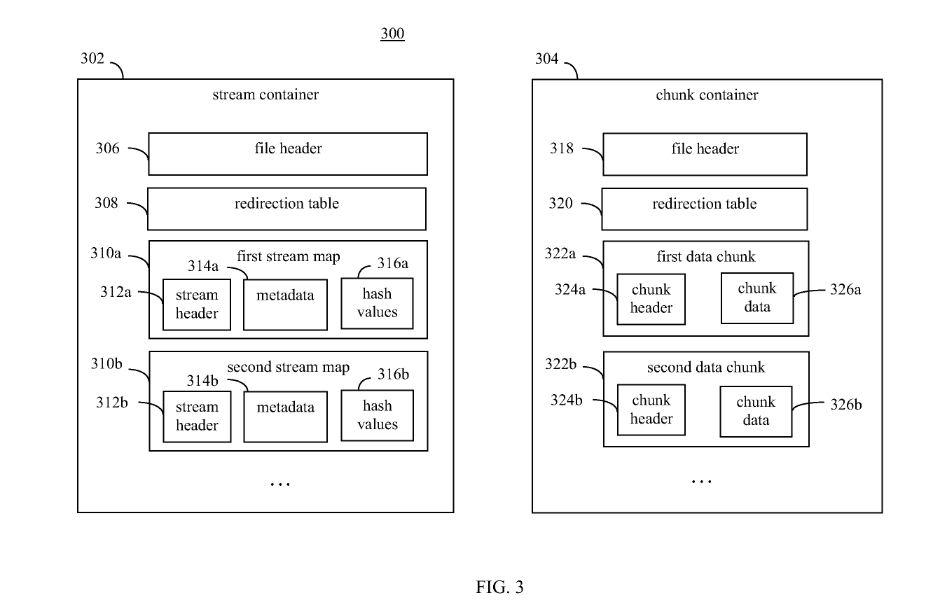

Stream container 202 and chunk container 204 may be configured in various ways, in embodiments. For instance, FIG. 3 shows a block diagram of a chunk store 300, according to an example embodiment. Chunk store 300 is an example of chunk store 118 of FIG. 2. As shown in FIG. 3, chunk store 300 includes a stream container 302 and a chunk container 304. Stream container 302 is an example of stream container 202 of FIG. 2, and chunk container 304 is an example of chunk container 204 of FIG. 2. In the embodiment of FIG. 3, stream container 302 includes a file header 306, a redirection table 308, and a plurality of stream maps 310. First and second stream maps 310a and 310b are shown in FIG. 3 for purposes of illustration, but in embodiments, any number of stream maps 310 may be included in stream container 302, including hundreds, thousands, and even greater numbers of stream maps 310. Chunk container 304 includes a file header 318, a redirection table 320, and a plurality of data chunks 322. First and second data chunks 322a and 322b are shown in FIG. 3 for purposes of illustration, but in embodiments, any number of data chunks 322 may be included in chunk container 304, including hundreds, thousands, and even greater numbers of data chunks 322. These features of FIG. 3 are described as follows.

File header 306 is a file header for stream container 302 in an embodiment where stream container 302 is stored as a file. File header 306 may include information associated with stream container 302, including a stream container identifier (e.g., a stream container identification number), etc.

Redirection table 308 is optionally present in stream container 302. When present, redirection table 308 may store information regarding changes in location in stream container 302 of any of stream maps 310. For example, first stream map 310a may be deleted from stream container 302, and second stream map 310b may be moved to the location of first stream map 310a (e.g., due to a defragmentation or compaction routine). Subsequent to the move, stream container 302 may be accessed by an application to retrieve second stream map 310b. However, the application may still be using the prior location of second stream map 310b. Redirection table 308 may include a mapping for second stream map 310b that indicates the current location of second stream map 310b. As such, the application may access redirection table 308 (e.g., indirectly, such as through API 116 of FIG. 1) to determine the current location of second stream map 310b, and may thereby be enabled to retrieve second stream map 310b from its new location.

Stream maps 310 are examples of stream maps 206 of FIG. 2. Each of stream maps 310 is used to define the sequences of data chunks 322 that make up a particular data stream. As shown in FIG. 3, each of stream maps 310 includes a stream header 312, metadata 314, and hash values 316. For instance, first stream map 310a is shown including stream header 312a, metadata 314a, and hash values 316a, and second stream map 310b is shown including stream header 312b, metadata 314b, and hash values 316b. Each stream header 312 includes information associated with the corresponding stream map 310, such as a stream map identifier (e.g., a stream map identification number), etc. Each metadata 314 includes information describing the data chunks 322 that make up the data stream defined by the corresponding stream map 310. Hash values 316 are optionally present. Hash values 316 are hash values for the data chunks 322 that make up the data stream defined by the corresponding stream map 310. Hash values 316 may be stored in stream maps 310 in order to provide efficient access to a hash vector of the data chunks that make up the corresponding data stream. For instance, this may be useful for wire data transfer scenarios where fast access to full list of data stream hashes (hashes for all the optimized file chunks) is desired.

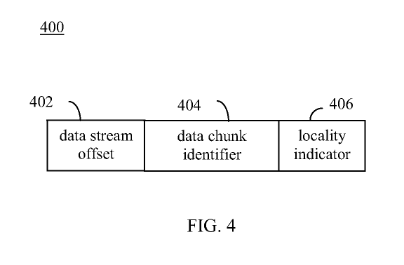

Various types of information may be included in metadata 314. For instance, FIG. 4 shows a block diagram of metadata 400, according to an example embodiment. Metadata 400 is an example of metadata 314 of FIG. 3. Metadata 400 is an example of metadata that may be included in stream map 310 for each referenced data chunk 322 (e.g., per-chunk metadata). As shown in FIG. 4, metadata 400 includes a data stream offset 402, a data chunk identifier 404, and a locality indicator 406. Data stream offset 402 indicates a location for the associated data chunk 322 in the data stream defined by the particular stream map 310. For example, data stream offset 402 may indicate a number of bytes from the beginning of the data stream, or from other reference point in the data stream, at which the associated data chunk 322 begins. Data chunk identifier 404, also known as a chunk id or “reliable chunk locator,” is a reference or pointer to the corresponding data chunk 322 in a chunk container 304. For instance, data chunk identifier 404 for a particular data chunk enables the data chunk to reliably be located in a chunk container 304. Data chunk identifier 404 may have various forms, including the example forms described in further detail below (e.g., with reference to FIG. 13). Locality indicator 406 is information that represents a chunk insertion order in chunk container 304, enabling a determination to be made of which data chunks 322 may be referenced by a common stream map 310. For instance, locality indicator 406 enables data chunks 322 associated with a same stream map 310 to be stored contiguously in a chunk container 304, or to be stored closely together if contiguous storage is not straightforward (e.g., due to multiple stream maps 310 referencing the same data chunk 322). Locality indicator 406 may further be used by other data deduplication components such as a chunk hash index to improve hash lookup and insertion performance or by a defragmenter to rearrange data chunks to decrease latency for specific data streams.

With reference to chunk container 304 of FIG. 3, file header 318 is a file header for chunk container 302 in an embodiment where chunk container 304 is stored as a file. File header 318 may include information associated with chunk container 304, including a chunk container identifier (e.g., a chunk container identification number), a chunk container generation indicator that indicates a revision number of chunk container 304, etc.

Redirection table 320 is optionally present in chunk container 304. When present, redirection table 320 may store information regarding changes in location in chunk container 304 of any of data chunks 322, in a similar manner as how redirection table 308 of stream container 302 handles changes in location of stream maps 310.

Data chunks 322 are examples of data chunks 208 of FIG. 2. As shown in FIG. 3, each of data chunks 322 includes a chunk header 324 and chunk data 326. For instance, first data chunk 322a includes chunk header 324a and chunk data 326a, and second data chunk 322b includes chunk header 324b and chunk data 326b. Each chunk header 312 includes information associated with the corresponding data chunk 322, such as a data chunk identifier, etc. Each chunk data 326 includes the corresponding data, which may be in compressed or non-compressed form.

Stream maps 310 and data chunks 322 are stored in stream container 302 and chunk container 304, respectively, to enable data de-duplication. For instance, chunk store interface 116 of FIG. 1 may receive data chunks 124 associated with data streams 132, and may store the data chunks in chunk store 300 of FIG. 3. For instance, for a particular data stream 132, chunk store interface 116 may generate a stream map that is stored in a stream container 302 as a stream map 310 that references one or more data chunks 322 stored in one or more chunk containers 304 by chunk store interface 116.

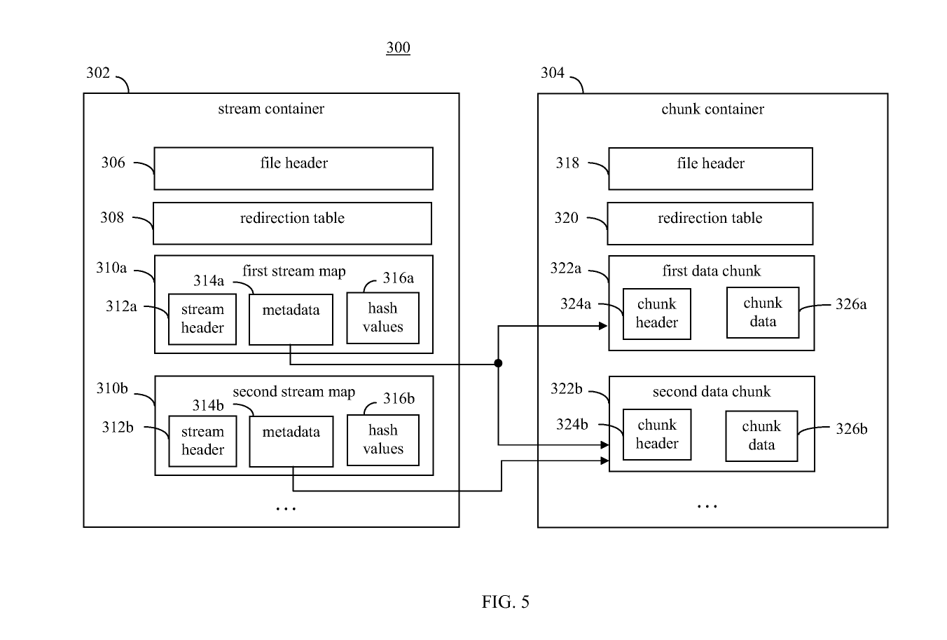

For instance, FIG. 5 shows chunk store 300 of FIG. 3, and indicates some data chunks 322 that are referenced by stream maps 310, according to an example embodiment. As shown in FIG. 5, first stream map 310a includes metadata 314a that includes references to first and second data chunks 322a and 322b in chunk container 304. Thus, first and second data chunks 322a and 322b are included in the source data stream associated with first stream map 310a. For example, metadata 314a may include a data stream offset 402 value for first data chunk 322a that indicates a location of first data chunk 322a in the source data stream defined by first stream map 310a, a data chunk identifier 404 for first data chunk 322a in chunk container 304 (e.g., the data chunk identifier for first data chunk 322a stored in chunk header 324a), and a locality indicator 406 for first data chunk 322a. Furthermore, metadata 314a may include a data stream offset 402 value for second data chunk 322b that indicates a location of second data chunk 322b in the source data stream, a data chunk identifier 404 for second data chunk 322b in chunk container 304 (e.g., the data chunk identifier for second data chunk 322b stored in chunk header 324b), and a locality indicator 406 for second data chunk 322b. In an embodiment, first and second data chunks 322a and 322b may have a same value for their locality indicators that is generated to correspond to the source data stream defined by first stream map 310a, and that indicates that first and second data chunks 322a and 322b are contiguously (adjacently) stored in chunk container 304.

Furthermore, second stream map 310b includes metadata 314b that includes references to second data chunk 322b in chunk container 304. For example, metadata 314b may include a data stream offset 402 value for second data chunk 322b that indicates a location of second data chunk 322b in the source data stream defined by second stream map 310b, a data chunk identifier 404 for second data chunk 322b in chunk container 304 (e.g., the data chunk identifier for second data chunk 322b stored in chunk header 324b), and a locality indicator 406 for second data chunk 322b. The locality indicator 406 in metadata 314b for second data chunk 322b has the same value as the locality indicators generated for first and second data chunks 322a and 322b because second data chunk 322b was originally stored in chunk container 304 for first stream map 310a. Any further data chunks 322 (not shown in FIG. 5) that were newly stored in chunk container 304 when the source data stream defined by second stream map 310b was stored in chunk store 300 are assigned a new value for locality indicator 406.

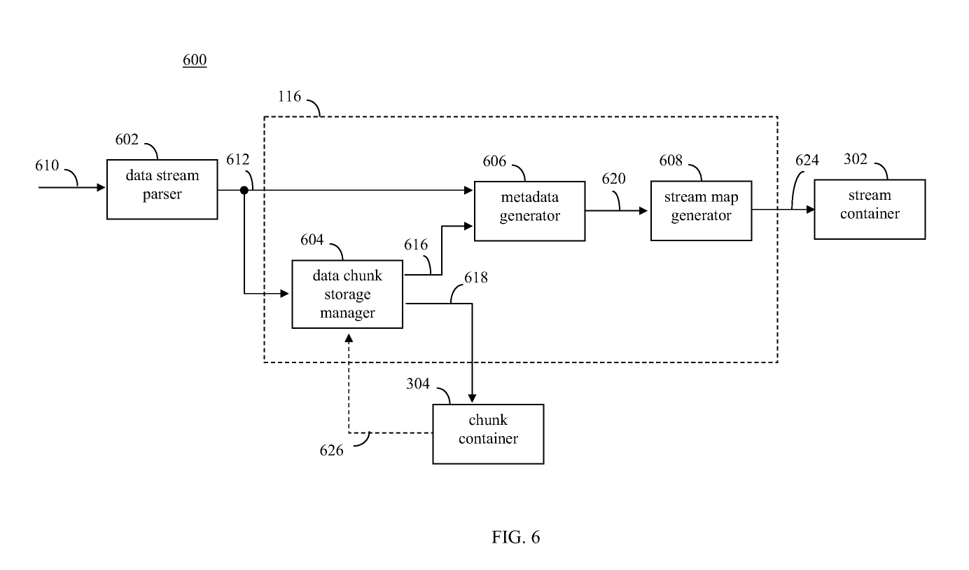

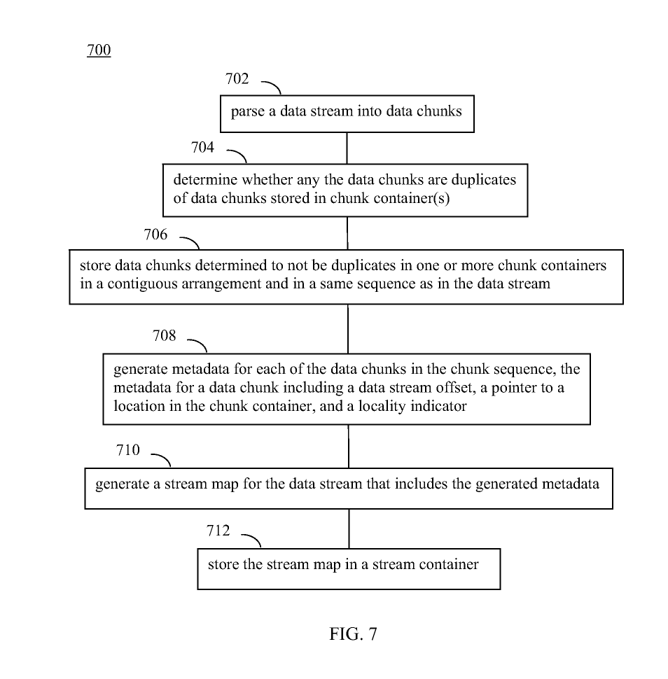

Chunk store interface 116 of FIG. 1 may be configured in various ways to store data streams in chunk store 300 of FIG. 3. For instance, FIG. 6 shows a block diagram of data stream store system 600, according to example embodiment. As shown in FIG. 6, data stream store system 600 includes a data stream parser 602, chunk store interface 116, stream container 302, and chunk container 304. In an embodiment, data stream parser 602 may be included in data deduplication module 104 of FIG. 1. In the embodiment of FIG. 6, chunk store interface 116 includes a data chunk storage manager 604, a metadata generator 606, and a stream map generator 608. These features of FIG. 6 are described as follows with respect to FIG. 7. FIG. 7 shows a flowchart 700 for storing a data stream, according to an example embodiment. In an embodiment, system 600 of FIG. 6 may operate according to flowchart 700. Further structural and operational embodiments will be apparent to persons skilled in the relevant art(s) based on the discussion regarding flowchart 700. Flowchart 700 and system 600 are described as follows.

Flowchart 700 begins with step 702. In step 702, a data stream is parsed into data chunks. For example, as shown in FIG. 6, data stream parser 602 may receive a data stream 610. Data stream 610 may include one or more files and/or portions of files, similarly to data stream 132 of FIG. 1. Data stream parser 602 is configured to parse data stream 610 into a sequence of data chunks, indicated as data chunk sequence 612. For instance, in an embodiment, data chunk sequence 612 may include the sequence of data chunks in the order the data chunks are located in data stream 610. The data chunks of data chunk sequence 612 may have the same size or may have different sizes.

In step 704, whether any of the data chunks are duplicates of data chunks stored in chunk container(s) is determined. For example, as shown in FIG. 6, data chunk storage manager 604 receives data chunk sequence 612. Data chunk storage manager 604 is configured to determine whether any of the data chunks of data chunk sequence 612 are already stored in chunk container(s) 304, and therefore are duplicates. For example, in an embodiment, as shown in FIG. 6, data chunk storage manager 604 may receive data chunk information 626 from chunk container(s) 304, which may include hash values for each data chunk 322 stored in chunk container 304. In another embodiment, data chunk storage manager 604 may receive hash values 316 (FIG. 3) from stream container(s) 302, which are hash values for data chunks 322 stored in chunk container(s) 304. Data chunk storage manager 604 may generate a hash value for each data chunk of data chunk sequence 612, and may compare the generated hash values to the hash values received in data chunk information 626 (or from stream container(s) 302) to determine which data chunks of data chunk sequence 612 are already stored in chunk container(s) 304. In further embodiments, data chunk storage manager 604 may determine which data chunks of data chunk sequence 612 are already stored in chunk container(s) 304 in other ways, as would be known to persons skilled in the relevant art(s).

As shown in FIG. 6, data chunk storage manager 604 generates a stored chunk indication 616, which indicates which data chunks of data chunk sequence 612 are already stored in chunk container(s) 304.

Referring back to FIG. 7, in step 706, data chunks determined to not be duplicates are stored in one or more chunk containers in a contiguous arrangement and in a same sequence as in the data stream. For example, in an embodiment, data chunk storage manager 604 may be configured to store the data chunks of data chunk sequence 612 that were not determined to be stored in chunk container(s) 304. For example, in an embodiment, data chunk storage manager 604 may generate a chunk header 324 (e.g., a data chunk identifier) for each new data chunk, and store each new data chunk as a data chunk 322 with chunk header 324 and chunk data 326. Furthermore, in an embodiment, data chunk storage manager 604 is configured to store the new data chunks in a contiguous arrangement in a chunk container 304, in a same order as in the source data stream (e.g., in the order received in data chunk sequence 612). Note that in another embodiment, the data chunks determined not to be duplicates may be stored in multiple chunk containers in a manner that facilitates parallel read of the data chunks.

In step 708, metadata is generated for each of the data chunks in the chunk sequence, the metadata for a data chunk including a data stream offset, a pointer to a location in the chunk container, and a locality indicator. For example, as shown in FIG. 6, metadata generator 606 may receive data chunk sequence 612 and stored chunk indication 616. In an embodiment, metadata generator 606 may be configured to generate metadata (e.g., metadata 314 of FIG. 3). Metadata generator 606 may generate metadata for each data chunk of data chunk sequence 612, including data stream offset 402, data chunk identifier 404, and locality indicator 406. For data chunks determined to already be stored in chunk container 304 (in step 704), data chunk identifier 404 is configured to point at the already stored data chunk. For data chunks newly stored in chunk container 304 in step 708, data chunk identifier 404 is configured to point at the newly stored data chunk.

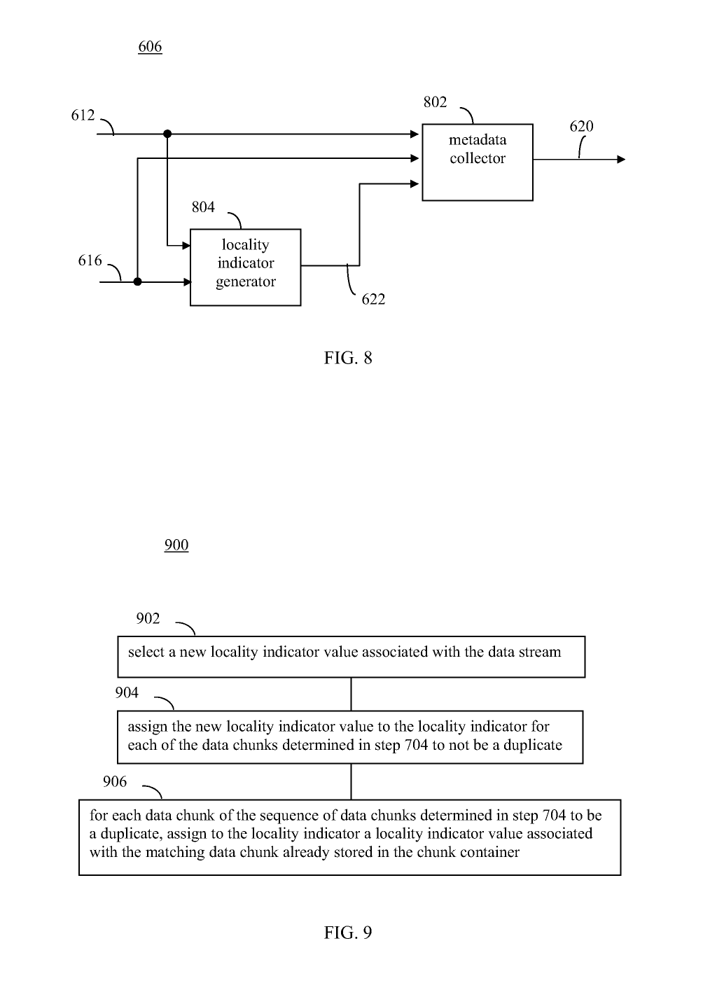

Metadata generator 606 may be configured in various ways to generate metadata, in embodiments. For instance, FIG. 8 shows a block diagram of metadata generator 606, according an example embodiment. As shown in FIG. 8, metadata generator 606 includes a metadata collector 802 and a locality indicator generator 804. As shown in FIG. 8, locality indicator generator 804 receives data chunk sequence 612 and stored chunk indication 616. Locality indicator generator 804 is configured to generate a locality indicator 406 for each data chunk of data chunk sequence 612 not indicated by stored chunk indication 616 to already be stored in chunk container 304. As shown in FIG. 8, locality indicator generator 804 generates one or more locality indicator values 622, which indicates locality indicators 406 for each data chunk in data chunk sequence 612.

Metadata collector 802 receives locality indicator values 622, data chunk sequence 612, and stored chunk indication 616. Metadata collector 802 collects metadata for each data chunk of data chunk sequence 612. For instance, metadata collector 802 may determine a data stream offset 402 for each data chunk received in data chunk sequence 612. For example, metadata collector 802 may determine a data stream offset 402 for each data chunk based on the order in which data chunks are received in data chunk sequence 612, and/or a length of the received data chunks (e.g., a data stream offset 402 may be set for a data chunk as a sum of the lengths of the data chunks received in data chunk sequence 612 prior to the data chunk, or in other manner). Metadata collector 802 may generate a data chunk identifier 404 for each data chunk to identify each data chunk in chunk container 304. Metadata collector 802 assigns to each data chunk the corresponding locality indicator value received in locality indicator values 622. Metadata collector 802 outputs the metadata associated with each data chunk received in data chunk sequence 612 as data chunk metadata 620.

In an embodiment, metadata generator 606 may assign locality indicator values 622 according to FIG. 9. FIG. 9 shows a flowchart 900 for assigning locality indicators, according to an example embodiment. Flowchart 900 begins with a step 902. In step 902, a new locality indicator value associated with the data stream is selected. For example, when data chunk sequence 612 is received for a data stream, locality indicator generator 804 may select a new locality indicator value to be associated with the data stream. The new locality indicator value is unique, being different from the locality indicator values being used for previously received data streams already having data chunks stored in chunk container 304. For instance, the new locality indicator value may be a unique number generated to be associated with a data stream. Locality indicator generator 804 outputs the selected locality indicator value as selected locality indicator value 622.

In step 904, the new locality indicator value is assigned to the locality indicator for each of the data chunks determined in step 704 to not be a duplicate. For instance, as shown in FIG. 8, selected locality indicator value 622 is received by metadata collector 802. Metadata collector 802 is configured to assign selected locality indicator value 622 as locality indicator 406 to each data chunk of a first set of data chunks of data chunk sequence 612 indicated by stored chunk indication 616 to not already be stored in chunk container 304 (i.e., the new data chunks).

In step 906, for each data chunk determined in step 704 to be a duplicate, a locality indicator value associated with the matching data chunk already stored in the chunk container is assigned to the locality indicator. For example, each data chunk 322 that is already stored in chunk container 304 (a duplicate data chunk) has a locality indicator 406 already assigned, because a locality indicator value is assigned to a data chunk 322 when the data chunk 322 is originally stored in chunk container 304. In an embodiment, for data chunks indicated by stored chunk indication 616 to be already stored in chunk container, metadata collector 802 assigns the locality indicator value associated with the data chunk already stored in chunk container 304 to the matching/duplicate data chunk received in data chunk sequence 612. Thus, one or more sets of data chunks in data chunk sequence 612 may each be assigned a corresponding locality indicator value associated with the corresponding data chunks stored in chunk container 304.

Referring back to FIG. 7, in step 710, a stream map is generated for the data stream that includes the generated metadata. For example, as shown in FIG. 6, stream map generator 608, receives data chunk metadata 620 for each data chunk received in data chunk sequence 612 for a particular data stream. Stream map generator 608 generates a stream map 624 associated with the data stream that includes data chunk metadata 620 for each received data chunk. Furthermore, stream map generator 608 may generate a stream header 312 for stream map 624, and may include hash values 316 for each received data chunk in stream map 624.

In step 712, the stream map is stored in a stream container. For instance, as shown in FIG. 6, stream map generator 608 may store (or “persist”) stream map 624 in stream container 302 (e.g., as a stream map 310).

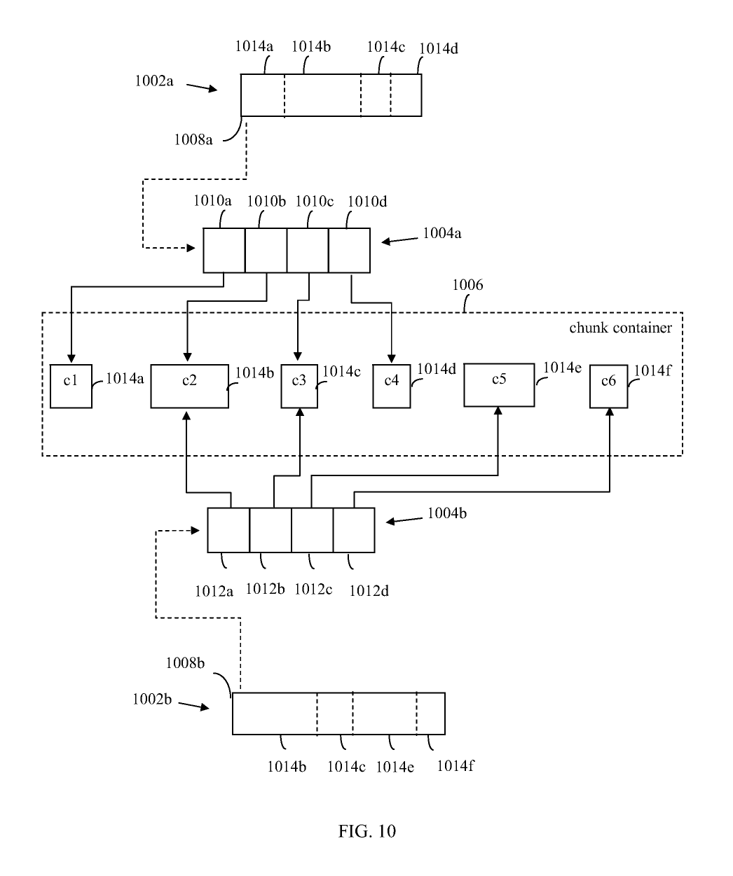

FIG. 10 shows a block diagram that illustrates an example of the storing of data streams in a data store, according to an embodiment. FIG. 10 is provided for purposes of illustration, and is not intended to be limiting. In the example of FIG. 10, a first data stream 1002a is stored in a data store, followed by a second data stream 1002b being stored in the data store. A stream link 1008a (also known as “stream pointer” or “stream stub”) is shown for first data stream 1002a, and a stream link 1008b is shown for second data stream 1002b. As shown in FIG. 10, first data stream 1002a includes four data chunks 1014a-1014d. A stream map 1004a may be generated for first data stream 1002a, and the four data chunks 1014a-1014d may be stored in a chunk container 1006, as described above. Stream map 1004a includes pointers (represented by arrows in FIG. 10) to each of data chunks 1014a-1014d. Data chunks 1014a-1014d may be categorized in a single set of all new, unique data chunks to chunk container 1006. As such, data chunks 1014a-1014d may be stored in chunk container 1006 in a contiguous arrangement, in a same order as in data stream 1002a. For example, data chunks 1014a-1014d may be the first four data chunks stored in chunk container 1006, or if one or more data chunks are already stored in chunk container 1006, data chunks 1014a-1014d may be stored in chunk container 1006 immediately after the already stored data chunks. Each of data chunks 1014a-1014d is assigned the same locality indicator value in stream map 1004a, the locality indicator value selected for first data stream 1002a.

Second data stream 1002b includes four data chunks 1014b, 1014c, 1014e, and 1014f. A stream map 1004b may be generated for second data stream 1002b. Data chunks 1014b, 1014c, 1014e, and 1014f may be categorized into two sets of data chunks according to step 704 of flowchart 700: a first set that includes chunks 1014b and 1014c, which already have copies residing in chunk container 1006 (due to the chunk sequence of first data stream 1002a), and a second set that includes chunks 1014e and 1014f, which are new, unique data chunks (that do not have copies already stored in chunk container 1006). Because data chunks 1014b and 1014c are already stored in chunk container 1006, stream map 1004b includes pointers (values for data chunk identifier 404) to data chunks 1014b and 1014c already stored in chunk container 1006. Thus, data chunks 1014b and 1014c may be stored as pointers to existing data chunks in chunk container 1006 without storing chunk data of data chunks 1014b and 1014c. Because data chunks 1014e and 1014f are not already stored in chunk container 1006, data chunks 1014e and 1014f may be stored in chunk container 1006, as described above. For instance, because data chunks 1014e and 1014f are new, unique data chunks to chunk container 1006, chunks 1014e and 1014f may be stored in chunk container 1006 in a contiguous arrangement, in a same order as in data stream 1002b, after the last stored data chunk currently stored in chunk container 1006 (e.g., data chunk 1014d). Stream map 1004b includes first-fourth data chunk identifiers 1012a-1012d, which point to data chunks 1014b, 1014c, 1014e, and 1014f stored in chunk container 1006, respectively. In stream map 1004b, data chunks 1014b and 1014c are assigned the locality indicator value associated with first data stream 1002a (according to step 906 in FIG. 9), and data chunks 1014e and 1014f are assigned the locality indicator value selected for second data stream 1002b (e.g., according to steps 902 and 904 in FIG. 9).

Note that any number of additional data streams 1002 may be stored in a similar manner following data streams 1002a and 1002b. Furthermore, note that in the example of FIG. 10, data chunks of second stream map 1004b were each assigned one of two locality indicator values—either the new locality indicator value selected for second stream map 1004b, or the locality indicator value associated with the data chunks of first stream map 1004a. In embodiments, data chunks of a particular stream map may be assigned one of any number of locality indicator values, depending on the number of different locality indicators associated with data chunks of the stream map that are already present in the chunk container. For instance, as described above, new data chunks to a chunk container may be assigned the new locality indicator value selected for the particular data stream associated with the stream map. Furthermore, any number of data chunks referenced by the stream map that are already present in the chunk container are assigned the corresponding locality indicator values of the data chunks already present in the chunk container. This may mean that any number of one or more sets of data chunks of the data stream may be assigned corresponding locality indicator values, such that data chunks of the data stream may be assigned locality indicators selected from two, three, or even more different locality indicator values.

As such, locality indicators of stream map metadata enable the locality of data chunks in data streams to be ascertained. This is because duplicate data chunks tend to occur in groups. When a new data stream contains an already known data chunk (already stored in the chunk container), there is a reasonable probability that the next data chunk in the new data stream is also a duplicate data chunk (already stored in the chunk container). Because new, original data chunks are stored in the chunk container adjacent to one another according to the locality indicator, the already present data chunks that the new data stream references are more likely to also be contiguously stored in the chunk container. This aids in improving the performance of reading and/or processing optimized data streams from a chunk store. For instance, a rehydration module configured to re-assemble a data stream based on the corresponding stream map and data chunks can perform a read-ahead on the data chunks stored in the chunk container, expecting to find the next data chunk needs in the read-ahead buffer. Furthermore, chunk store maintenance tasks like defragmentation and compaction can perform their tasks while attempting to maintain the original locality by keeping the existing adjacent chunks together as they are move around the chunk container.

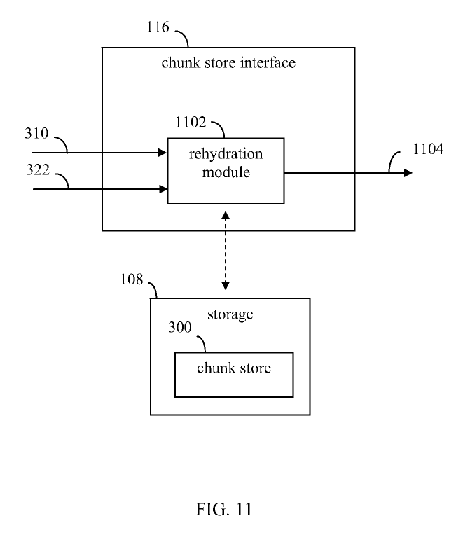

For instance, after data streams are optimized and stored in chunk store 300 in the form of stream maps 310 and data chunks 322, the data streams may be read from chunk store 300. FIG. 11 shows a block diagram of chunk store interface 116 including a rehydration module 1102, according to an example embodiment. Rehydration module 1102 is configured to re-assemble a requested data stream (e.g., requested according to data stream request 120 shown in FIG. 1). For instance, for a data stream to be read from chunk store 300 in response to a data stream request 120 (FIG. 1), rehydration module 1102 determines and receives the stream map 310 referenced by the optimized file of the data stream request 120 from chunk store 300 (e.g., at the reparse location). For instance, rehydration module 1102 may provide a stream map identifier of request 120 to chunk store 300 of FIG. 3. Chunk store 300 retrieves the corresponding stream map 310 based on the stream map identifier (e.g., container identifier and chunk offset value if the container generation value matches, or container identifier, local identifier, and redirection table if the container generation value does not match), and rehydration module 1102 may regenerate or “rehydrate” the data stream according to the retrieved stream map 310. Note that a stream map may be identified in other ways, such as through the use of a separate index that translates the stream map identifier for the stream map into the exact position of the stream map on disk. The retrieved stream map 310 includes pointers (data chunk identifier 404 of FIG. 4) to each of the data chunks in chunk container 304 included in the data stream. Rehydration module 1102 uses the pointers to retrieve each of the data chunks 322. Rehydration module 1102 may use data stream offsets 402 included in the retrieved stream map 310 (e.g., plus data chunk length information that may be included in the retrieved stream map 310) to arrange the retrieved data chunks 322 in the proper order to re-generate the data stream, which is output by rehydration module 1102 as data stream 1104.

Through the use of locality indicators 406, sequential reads of data chunks 322 from chunk container 304 may be performed. For instance, when a file stream is being accessed in chunk store 300 by rehydration module 1102 using sequential I/O (input/output) requests, or any I/O requests that encompass more than one data chunk boundary, fast access to data chunks is enabled by the contiguous storage of data chunks according to their original data stream sequence. This is because at the time that chunk store 300 creates stream maps 310, new data chunks are stored in chunk container 304 in an optimized manner such that the data chunks may be rapidly read later. For example, data chunks may be stored sequentially in related containers that can be processed in parallel (either for data chunk insertion and/or for data chunk read). As such, during a sequential data access by rehydration module 1102, data chunks belonging to the same data stream are likely to be stored contiguously, such contiguous data chunks may be accessed and read with a single data access “seek” (e.g., movements forward or backward through a chunk container to find a next stored data chunk to read), and fragmentation is reduced to non-unique data chunks (the data chunks referenced by a stream map that were already present in the chunk container prior to storing the corresponding data stream). Data access seeks during sequential data access are limited to the case where a data chunk or a series of chunks of a data stream are found to already exist in the chunk store. Stream map 310 provides an efficient metadata representation for optimized file metadata (e.g., metadata 314) that may be needed by other modules of a data deduplication system (e.g. a list of hash values used by a file replication module). Stream maps 310 are concise and can be cached in memory for fast access. Chunk store 300, or higher level data access layers, can cache frequently-accessed stream maps 310 (for optimized data streams frequently requested and rehydrated by rehydration module 1102) based on an LRU (least recently used) algorithm or other type of cache algorithm.

### C. Example Chunk Store Embodiments that Enable Reliable Locating of Data Chunks and Stream Maps

As described above, data chunks may be moved within a chunk container for various reasons, such as due to a compaction technique that performs garbage collection, or potentially for other reason Embodiments are described in this subsection for keeping track of the movement of data chunks within a chunk container.

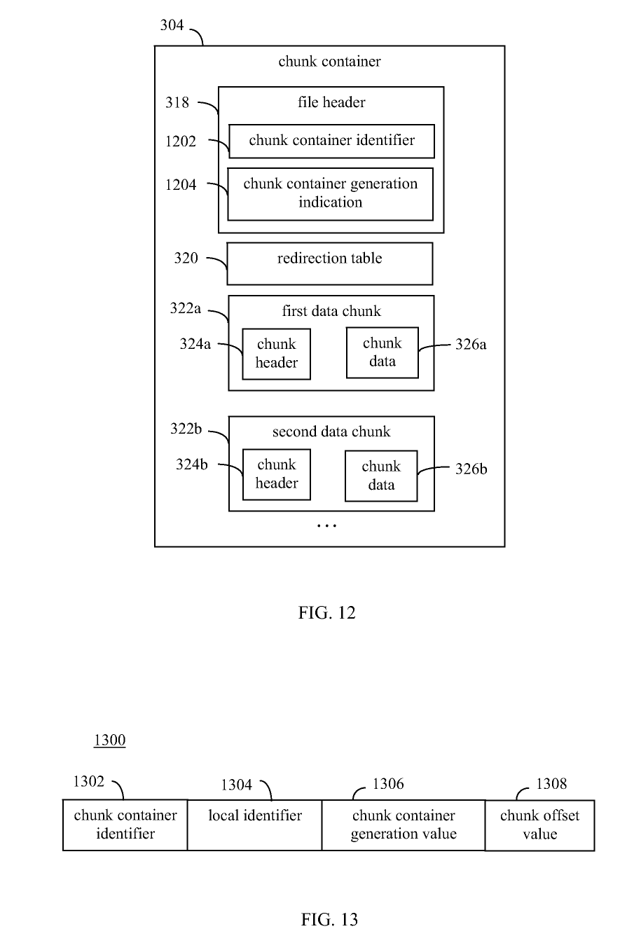

FIG. 12 shows a block diagram of chunk container 304, according to an example embodiment. As shown in FIG. 12, chunk container 304 is generally similar to chunk container 304 of FIG. 3, with the addition of a chunk container identifier 1202 and a chunk container generation indication 1204 included in file header 318. Chunk container identifier 1202 is a unique identifier (e.g., an identification number) assigned to chunk container 304 to distinguish chunk container 304 from other chunk containers that may be present in chunk store 300. Chunk container generation indication 1204 indicates a revision or generation for chunk container 304. For instance, each time that one or more data chunks 322 are moved within chunk container 304, generation indication 1204 may be modified (e.g., may be incremented to a next generation level, starting from a beginning generation level such as 0 or other beginning value).

In an embodiment, chunk container 304 may be identified by a combination of chunk container identifier 1202 and chunk container generation indication 1204 (e.g., may form a file name of chunk container 304). In another embodiment, chunk container 304 may be identified by a unique identifier assigned to chunk container 304, which may be mapped (e.g., using an indexing structure such as a hash table) to a particular physical data stream (e.g., a file, etc.) and a position (e.g., an offset) with the data stream. In an embodiment, both of chunk container identifier 1202 and chunk container generation indication 1204 may be integers. Chunk container 304 may have a fixed size (or fixed number of entries), or may have a variable size. For instance, in one example embodiment, each chunk container file that defines a chunk container 304 may be sized to store about 16,000 of chunks, with an average data chunk size of 64 KB, where the size of the chunk container file is set to 1 GB. In other embodiments, a chunk container file may have an alternative size.

Data chunks 322 stored in chunk container 304 may be referenced according to data chunk identifier 404 of metadata 400 (FIG. 4) in various ways. For example, a data chunk may have a unique identifier that may be mapped using an indexing structure (e.g., a hash table or similar structure) to a specific location within a particular container (e.g., by container identifier and offset within the container). In another example, FIG. 13 shows a block diagram of a data chunk identifier 1300, according to an example embodiment. In embodiments, stream maps 310 may store data chunk identifier 1300 in metadata 314 as data chunk identifier 404. As shown in FIG. 13, data chunk identifier 1300 includes a data chunk container identifier 1302, a local identifier 1304, a chunk container generation value 1306, and a chunk offset value 1308. Chunk container identifier 1302 has a value of chunk container identifier 1202 for the chunk container 304 in which the data chunk 322 is stored. Local identifier 1304 is an identifier (e.g., a numerical value) that is assigned to a data chunk 322, and is unique to the assigned data chunk 322 within the chunk container 304 in which the data chunk 322 is stored (e.g., is a unique per-container identifier for the data chunk). Chunk container generation value 1306 has the value of chunk container generation indication 1204 for the chunk container 304 in which the data chunk 322 is stored, at the time the data chunk 322 is stored in the chunk container 304. It is noted that the value assigned to a data chunk 322 for local identifier 1304 is unique for the data chunk 322 over the entire history of the chunk container 304 (e.g., over all generations), and is immutable. Chunk offset value 1308 is an offset of the data chunk 322 in chunk container 304 at the time that the data chunk 322 is added to chunk container 304.

Thus, according to the embodiment of FIG. 13, data chunks 322 may be referenced by stream map 310 by data chunk identifiers 1300, which include chunk offset values 1308 indicating an offset for the data chunks 322 in chunk container 304 when they were stored. However, if a data chunk 322 is subsequently moved in chunk container 304 (i.e., an offset for the data chunk 322 in chunk container 304 changes), an existing data chunk identifier 1300 for the data chunk 322 used in a stream map 310 may have an incorrect value for chunk offset value 1308.

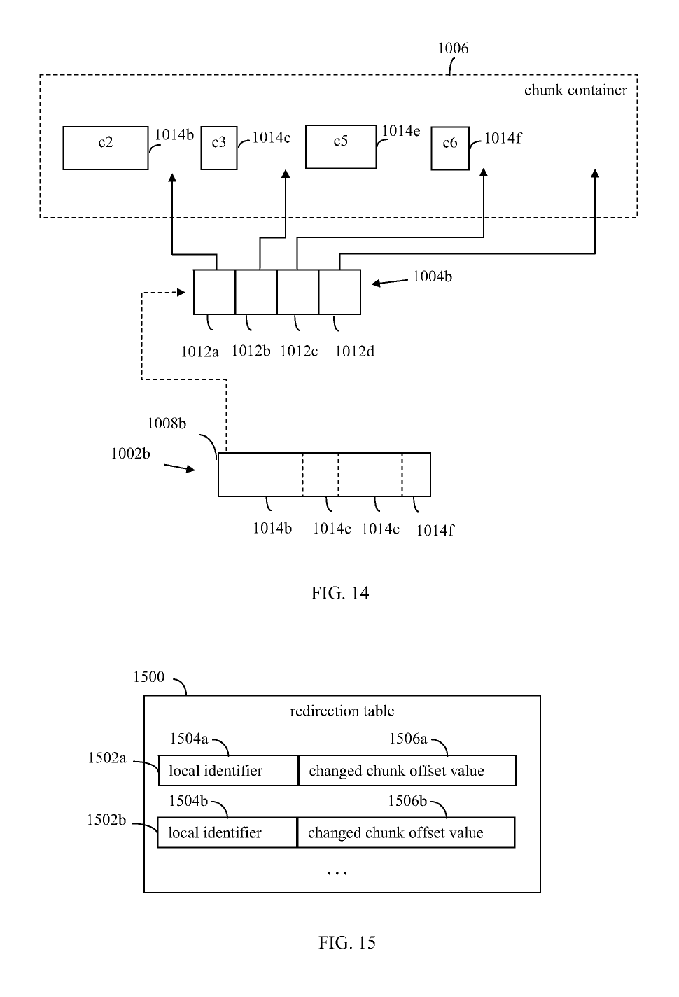

This concept is illustrated in FIG. 14. FIG. 14 shows the example of FIG. 10, where data streams are stored in a data store, and further illustrates the effect of the removal of data chunks from the data store, according to an embodiment. As shown in FIG. 14, similarly to FIG. 10, second data stream 1002b has a corresponding stream map 1004b (e.g., stored in a stream container 302, not shown in FIG. 14) and has data chunks 1014b, 1014c, 1014e, and 1014f stored in chunk container 1006. However, in contrast to FIG. 10, first data stream 1002a has been removed from the chunk store. As such, first stream map 1004a is no longer present. Furthermore, data chunks 1014a and 1014d, which were only referenced by stream map 1004a in this example, are removed from chunk container 1006 (e.g., by a garbage collection technique). Still further, because data chunks 1014a and 1014d are no longer present in chunk container 1006, leaving unused space/storage gaps, a compaction algorithm has moved 1014b, 1014c, 1014e, and 1014f in chunk container 1006 to reclaim the unused space. As shown in FIG. 14, data chunk 1014b has been shifted to a first offset location in chunk container 1006 (where data chunk 1014a was previously located, data chunk 1014c has been shifted to another offset location to contiguously follow data chunk 1014b, data chunk 1014e has been shifted to another offset location to contiguously follow data chunk 1014c, and data chunk 1014f has been shifted to another offset location to contiguously follow data chunk 1014e in chunk container 304. In this manner, the storage space in chunk container 304 previously filled by data chunks 1014a and 1014d may be reclaimed.

However, because data chunks 1014b, 1014c, 1014e, and 1014f have moved in chunk container 1006, data chunk identifiers 1012a-1012d in stream map 1004b no longer point to data chunks 1014b, 1014c, 1014e, and 1014f (e.g., the arrows representing pointers 1012a-1012d are shown pointed at the prior positions for data chunks 1014b, 1014c, 1014e, and 10140. If stream map 1004b is used in an attempt to rehydrate data stream 1002b, the attempt will fail because data chunks 1014b, 1014c, 1014e, and 1014f are not retrievable at their prior locations. As such, it is desired to have a technique for locating data chunks 1014b, 1014c, 1014e, and 1014f at their new offsets.

In an embodiment, a chunk store may implement a reliable chunk locator that may be used to track data chunks that have moved. In contrast to conventional techniques, the reliable chunk locator does not use a global index for mapping data chunk identifiers to a physical chunk location. Conventional techniques use a global index that maps chunk identifiers to the chunk data physical location. The scale of storage systems (e.g., 100 s of Terabytes or greater) and an average chunk size (e.g. 64 KB) make such a global index to be very large. If such a global index is fully loaded in memory it will consume a large amount of the available memory and processor resources. If the index is not loaded in memory, data accesses become slow because portions of the index need to be constantly paged into memory. Embodiments described herein do not use such a global index, thereby preserving system resources.

In an embodiment, the reliable chunk locator is implemented in the form of a redirection table, such as redirection table 320 of chunk container 304 in FIG. 3. The redirection table may be stored within chunk container 304 or separately. The redirection table described below refers to a signal container, but in another embodiment, a redirection table may serve multiple containers. The redirection table may store one or more entries for data chunks 322 that have been moved in chunk container 304. Each entry identifies a moved data chunk 322, and has a data chunk offset value indicating the location of the data chunk 322 in chunk container 304 at its new location. The redirection table may be referenced during rehydration of a data stream to locate any data chunks of the data stream that have moved.

For instance, FIG. 15 shows a block diagram of a redirection table 1500, according to an example embodiment. Redirection table 1500 is used to locate data chunks 322 (including stream maps stored as data chunks) if the data chunks 322 are moved within chunk container 304. For instance, redirection table 1500 enables data chunks 322 to be moved within chunk container 304 for space reclamation as part of a garbage collection and compaction process, and to still be reliably locatable based on the original chunk identifiers of the data chunks 322. As shown in FIG. 15, redirection table 1500 includes a plurality of entries 1502, such as a first entry 1502a and a second entry 1502b. Any number of entries 1502 may be included in redirection table 1500, including hundreds, thousands, and even greater numbers of entries 1502. Each entry 1502 includes a local identifier 1504 and a changed chunk offset value 1506. For instance, first entry 1502a includes a first local identifier 1504a and a first changed chunk offset value 1506a, and second entry 1502b includes a second local identifier 1504b and a second changed chunk offset value 1506b.

Local identifier 1504 is the unique local identifier assigned to a data chunk 322 when originally stored in chunk container 304 (local identifier 1304 of FIG. 13). Changed chunk offset value 1506 is the new chunk offset value for the data chunk 322 having the corresponding local identifier 1504 that was moved. As such, redirection table 1500 may be accessed using a local identifier for a data chunk to determine a changed chunk offset value for the data chunk.

For example, local identifier 1504a in FIG. 15 may be the local identifier assigned to data chunk 1014b in FIG. 14. Entry 1502a of redirection table 1500 may be accessed using the local identifier assigned to data chunk 1014b to determine changed chunk offset value 1506a, which indicates a new location for data chunk 1014b in chunk container 304.

Note that redirection table 1500 may have any size. For instance, in an embodiment, the size of redirection table 11500 may be bounded by (a predetermined maximum number of data chunks—a predetermined minimum number of data chunks deleted for compaction)×(a size of a redirection table entry). In some cases, relocations of data chunks may be infrequent. In an embodiment, after determining a changed chunk offset value for a data chunk, any pointers to the data chunk from stream maps can be modified in the stream maps to the changed chunk offset value, and the entry 1502 may be removed from redirection table 1500. In some situations, redirection table 1500 may be emptied of entries 1502 in this manner over time.

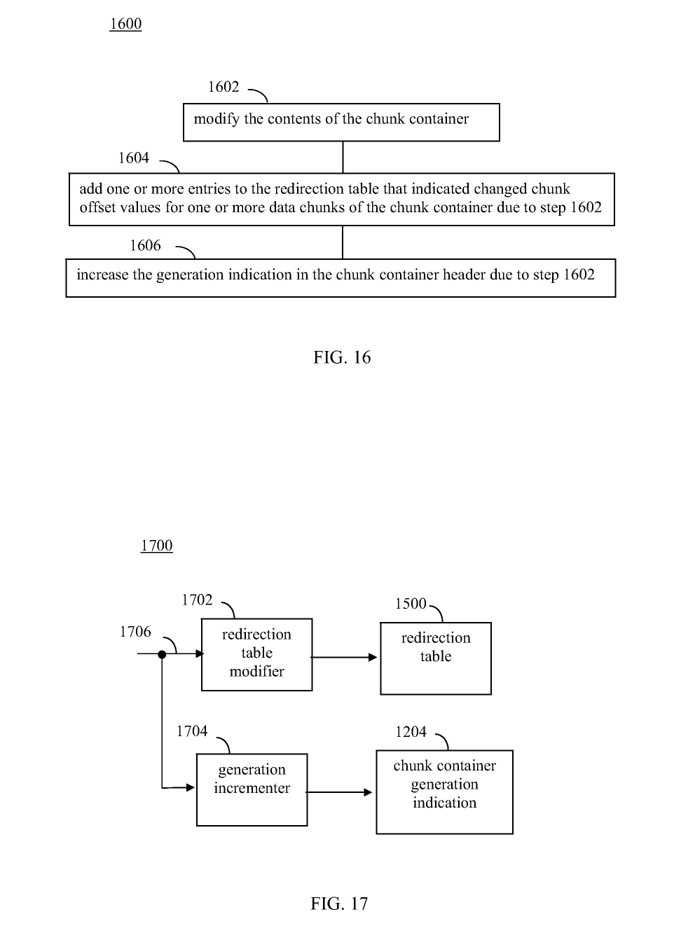

Entries to a redirection tables may be added in various ways. For instance, FIG. 16 shows a flowchart 1600 for storing a data stream, according to an example embodiment. Flowchart 1600 is described as follows with reference to FIG. 17. FIG. 17 shows a block diagram of a data chunk redirection system 1700, according to an example embodiment. As shown in FIG. 17, data chunk redirection system 1700 includes a redirection table modifier 1702 and a generation incrementer 1704. For instance, in an embodiment, data chunk redirection system 1700 may be implemented in chunk store interface 116 of FIG. 1. Further structural and operational embodiments will be apparent to persons skilled in the relevant art(s) based on the discussion regarding flowchart 1600. Flowchart 1600 is described as follows.

Flowchart 1600 begins with step 1602. In step 1602, the contents of the chunk container are modified. For example, in an embodiment, one or more data chunks 322 in chunk container 304 of FIG. 12 may be moved. Such data chunks 322 may be moved by a maintenance task (e.g., maintenance module 106 in FIG. 1), such as a defragmentation process, a compaction process after garbage collection, or other process.

In step 1604, one or more entries are added to the redirection table that indicated changed chunk offset values for one or more data chunks of the chunk container due to step 1602. For example, as shown in FIG. 17, redirection table modifier 1702 receives moved data chunks indication 1706, which indicates one or more data chunks 322 moved in chunk container 304 of FIG. 12 according to the maintenance task of step 1602. Moved data chunks indication 1706 may be received from the maintenance task that performed step 1602, and may indicate the chunk container identifier for chunk container 304, each moved data chunk (e.g., by local identifier 1304), and the offset of the moved data chunk in chunk container 304. Redirection table modifier 1702 is configured to add one or more entries 1502 to redirection table 1500 that correspond to the one or more moved data chunks 322 indicated in moved data chunks indication 1706. For example, for each moved data chunk 322, redirection table modifier 1702 generates an entry 1502 that indicates the local identifier value of the moved data chunk 322 as local identifier 1504, and indicates the new offset value of the moved data chunk 322 as changed chunk offset value 1506.

In step 1606, the generation indication in the chunk container header is increased due to step 1602. For example, as shown in FIG. 17, generation incrementer 1704 receives moved data chunks indication 1706, which indicates that data chunks have been moved in chunk container 304 of FIG. 12, as identified by the chunk container identifier received in moved data chunks indication 1706. As such, generation incrementer 1704 modifies chunk container generation indication 1204 of chunk container 304. For example, in an embodiment, chunk container generation indication 1204 may have an initial value of 0, and each time data chunks 322 are moved in chunk container 304, chunk container generation indication 1204 may be incremented to indicate a higher generation value. In other embodiments, chunk container generation indication 1204 may be modified in other ways.

As such, when a data chunk 322 of chunk container 304 of FIG. 12 is looked up using the data chunk identifier—data chunk identifier 1300 of FIG. 13—stored in the referencing stream map 310, chunk container generation indication 1204 of chunk container 304 may be checked to see if the current generation of chunk container 304 is the same as chunk container generation value 1306 of data chunk identifier 1300. If they are the same, the data chunk 322 can be located at the offset indicated by chunk offset value 1308 in data chunk identifier 1300. If not, redirection table 1500 is read to determine the changed offset value of the data chunk 322 in chunk container 304.

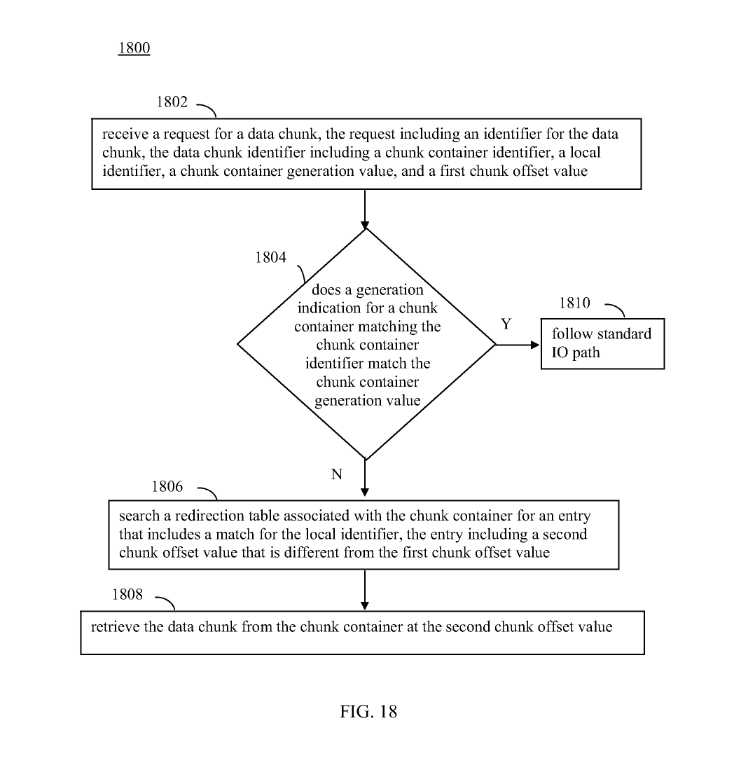

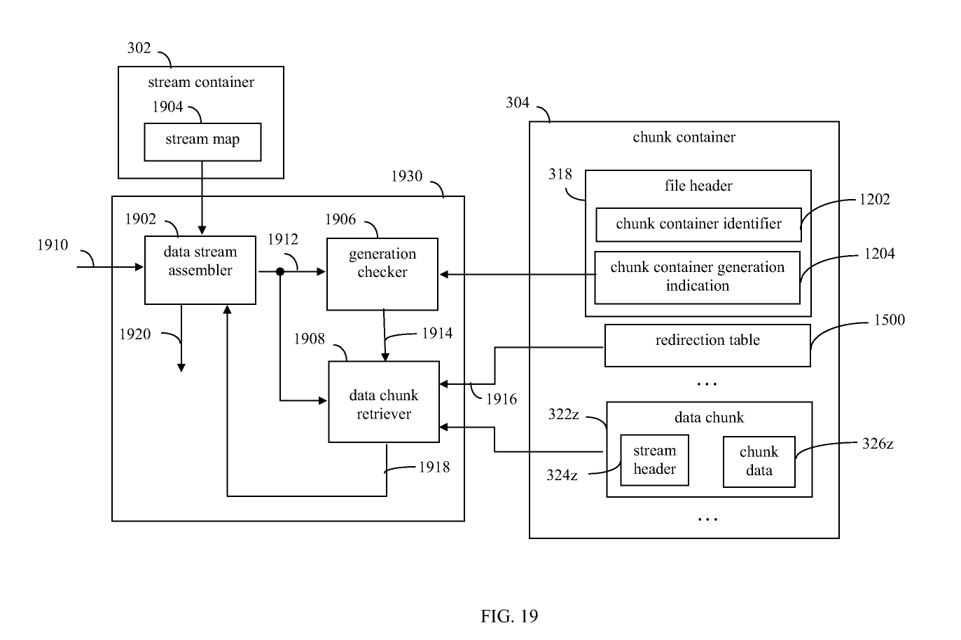

For instance, FIG. 18 shows a flowchart 1800 for locating data chunks in a chunk container, according to an example embodiment. For example, flowchart 1800 may be performed by rehydration module 1102 of FIG. 11 when rehydrating a data stream from a stream map. Flowchart 1800 is described as follows with reference to FIG. 19. FIG. 19 shows a block diagram of a rehydration module 1930 that communicates with stream container 302 and chunk container 304 to rehydrate a data stream according to a data stream request 1910, according to an example embodiment. As shown in FIG. 19, rehydration module 1930 includes a data stream assembler 1902, a generation checker 1906, and a data chunk retriever 1908. Further structural and operational embodiments will be apparent to persons skilled in the relevant art(s) based on the discussion regarding flowchart 1800. Flowchart 1800 and FIG. 19 are described as follows.

In FIG. 19, data stream assembler 1902 receives data stream request 1910, which indicates a stream map, such as stream map 1904 stored in stream container 302, corresponding to a data stream to be rehydrated. Data stream assembler 1902 processes stream map 1904, generating a data chunk request 1912 for each data chunk referenced by stream map 1904.

Flowchart 1800 begins with step 1802. In step 1802, a request for a data chunk is received, the request including an identifier for the data chunk, the data chunk identifier including a chunk container identifier, a local identifier, a chunk container generation value, and a first chunk offset value. For example, in an embodiment, data chunk request 1912 generated by data stream assembler 1902 may include data chunk identifier 1300 of FIG. 13 to identify a requested data chunk 322. As shown in FIG. 13, data chunk identifier 1300 may include a chunk container identifier 1302, a local identifier 1304, a chunk container generation value 1306, and a chunk offset value 1308 for the requested data chunk 322. A chunk container is located that has a chunk container identifier 1202 matching chunk container identifier 1302 of data chunk identifier 1300. For instance, the located chunk container may be chunk container 304 in FIG. 3. The located chunk container is accessed as follows to retrieve requested data chunks. Operation proceeds to step 1804.

In step 1804, whether a generation indication for a chunk container matching the chunk container identifier matches the chunk container generation value is determined. For example, as shown in FIG. 19, generation checker 1906 receives data chunk request 1912 for the requested data chunk. Generation checker 1906 accesses chunk container 304 (identified above as having a chunk container identifier 1202 that matches chunk container identifier 1302 of the requested data chunk 322). Generation checker 1906 is configured to compare chunk container generation indication 1204 for chunk container 304 to chunk container generation value 1306 for requested data chunk 322, and to output a generation match indication 1914. If their values do not match (e.g., the value of chunk container generation indication 1204 is greater than the value of chunk container generation value 1306 for requested data chunk 322), generation match indication 1914 indicates that a match was not found, and operation proceeds to step 1806. If their values do match, generation match indication 1914 indicates that a match was found, and operation proceeds to step 1810, where a standard I/O path (or other path) for retrieving the requested data chunk may be followed.

In step 1806, a redirection table associated with the chunk container is searched for an entry that includes a match for the local identifier, the entry including a second chunk offset value that is different from the first chunk offset value. For example, as shown in FIG. 19, data chunk retriever 1908 receives generation match indication 1914 and data chunk request 1912. If generation match indication 1914 indicates that a match was not found in step 1804, data chunk retriever 1908 accesses redirection table 1500 for a changed chunk offset value 1506 (FIG. 15) in an entry 1502 having a local identifier 1504 that matches local identifier 1304 of the requested data chunk 322. As shown in FIG. 19, data chunk retriever 1908 receives a second chunk offset value 1916 that is different from the first chunk offset value of chunk offset value 1308. Operation proceeds to step 1808.

In step 1808, the data chunk is retrieved from the chunk container at the second chunk offset value. For example, as shown in FIG. 19, data chunk retriever 1908 accesses chunk container 304 for a data chunk 322z located at second chunk offset value 1916. Data chunk 322z is the requested data chunk 322, having been moved in chunk container 304 from chunk offset value 1308 to second chunk offset value 1916.

As shown in FIG. 19, data chunk retriever 1908 outputs data chunk 1918, which is data chunk 322z in the current example. Data chunk 1918 is received by data stream assembler 1902. In this manner, data stream assembler 1902 receives all data chunks 322 referenced by stream map 1904 from data chunk retriever 1908, retrieved either directly from chunk container 304 according to the corresponding chunk offset value 1308, or from chunk container 304 as redirected by redirection table 1500. As shown in FIG. 19, data stream assembler 1902 generates a data stream 1920, which is the rehydrated form of the requested data stream indicated in data stream request 1910. Data stream assembler 1902 assembles together all of the received data chunks 322 as described elsewhere herein to form data stream 1920.

It is noted that the stream map reference identifier that resides in the reparse point of a data stream (e.g., stream link 1008a or 1008b in FIG. 10) may have the same structure as data chunk identifier 1300 of FIG. 13. As described above, a stream map 310 may have the form of a data chunk 322 that contains stream map metadata rather than end-user file data. As such, the procedure for addressing a stream map 310 may be the same as addressing a data chunk 322—both techniques may use the data chunk identifier 1300 structure. An optimized data stream references a stream map 310 by placing the data chunk identifier 1300 of the stream map 310 at the file reparse point (attached to the actual data stream/file object). The stream map identifier contains the [Container identifier, local identifier, generation value, offset value] information that may be used to locate (either directly, or through a redirection table) the stream map 310 data chunk inside stream container 302. As such, in an embodiment, a format and layout of a stream container 302 may be essentially the same as that of a chunk container 304.

### D. Example Garbage Collection Embodiments

When optimized data streams are deleted and their corresponding data chunks are no longer referenced, the storage space in a chunk store filled by the unused data chunks may be reclaimed. Embodiments are described in this subsection for performing “garbage collection” and compaction, where storage space filled by deleted data chunks is reclaimed. Embodiments may be performed relatively fast, and may scale proportionally to the quantity of optimized data that is present. Furthermore, such embodiments may be very efficient with regard to machine resource consumption (memory, disk I/O).

Many currently used data optimization solutions use reference counting (or reference list or reference table) to detect obsolete data chunks filling storage space that can be reclaimed. According to such solutions, a reference count is maintained for each data chunk that tallies a number of stored data streams that reference the corresponding data chunk. If the reference count reaches zero, the data chunk is no longer used and the storage space can be reclaimed. However, maintaining a reference count (or reference list or reference table) for data chunks is inefficient with regard to machine resources. This is because the reference count is updated every time a non-unique data chunk is received as part of a new data stream to be stored, and whenever the data chunk is deleted (e.g., whenever a data stream that refers to the data chunk is deleted). In embodiments, a reference count (or reference list or reference table) is not maintained for data chunks, conserving machine resources relative to currently used solutions. According to embodiments, when an optimized data stream (e.g., a file stored in a deduplicated manner) is deleted, the chunk store may mark/indicate the metadata chunk corresponding to the stream map for the data stream as deleted, but does not need to immediately interact with the data chunks. The data chunks may later be garbage collected, and the space filled by the data chunks may be compacted, as described in embodiments as follows.

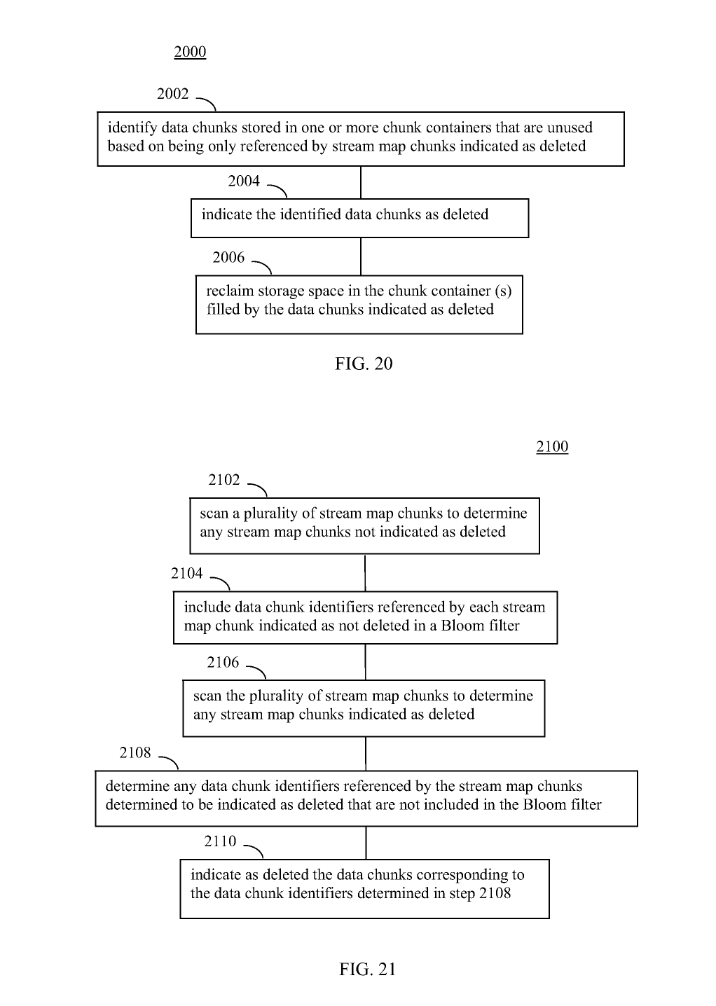

In an embodiment, garbage collection may be performed by identifying and marking obsolete data chunks, followed by compaction, where the containers are compacted to delete the identified obsolete data chunks and reclaim the storage space. For instance, FIG. 20 shows a flowchart 2000 for performing garbage collection for one or more chunk containers, according to an example embodiment. Flowchart 2000 may be performed by chunk store interface 116 of FIG. 1, in an embodiment. Further structural and operational embodiments will be apparent to persons skilled in the relevant art(s) based on the discussion regarding flowchart 2000. Flowchart 2000 is described as follows.

In step 2002 of flowchart 2000, data chunks stored in one or more chunk containers that are unused are identified based on being only referenced by stream map chunks indicated as deleted. For example, with reference to FIG. 1, chunk store interface 116 may receive requests to delete data streams stored in chunk store 118. Whenever such a request is received, chunk store interface 116 may indicate the data stream as deleted by providing a deleted indication in the stream map stored in chunk store 118 corresponding to the deleted data stream. For instance, with reference to FIG. 3, first and second stream maps 310a and 310b may be stored in stream container(s) 302 in the form of stream map data chunks (“stream map chunks”). If a data stream corresponding to second stream map 310b is requested to be deleted from chunk store 300 (e.g., as indicated by a stream map identifier/locator for second stream map 310b in the deletion request), chunk store interface 116 may include a deletion indication in metadata 314b of the stream map chunk of second stream map 310b. As such, each stream map chunk in stream container(s) 302 that includes a deletion indication corresponds to a data stream that has been requested to be deleted.

Metadata 314 of each stream map chunk/stream map 310 in stream container(s) 302 references one or more data chunks 322 in chunk container(s) 304 according to stored metadata 400 (FIG. 4). The referenced data chunks 322 are data chunks included the corresponding data stream. As such, chunk store interface 116 can identify the data chunks referenced by a stream map chunk indicated as deleted by analyzing metadata 400. For data chunks that are only referenced by stream map chunks/stream maps 310 that are indicated as deleted, chunk store interface 116 may identify the data chunks as unused.

In step 2004, data chunks identified as deleted are provided with indications. For example, the data chunks 322 in chunk container 304 identified in step 2002 as unused may be indicated by chunk store interface 116. Chunk store interface 116 may provide a deletion indication in chunk headers 324 or elsewhere in data chunks 322 identified for deletion. Alternatively, chunk store interface 116 may generate a delete log or other data structure that lists (e.g., by data chunk identifier and/or other information) data chunks 322 identified for deletion.

In step 2006, storage space in the chunk container(s) filled by the data chunks indicated as deleted is reclaimed. For instance, chunk store interface 116 may reclaim the storage space in chunk container 304 that was previously filled by data chunks 322 indicated in step 2004. Chunk store interface 116 may reclaim the storage space in various ways, including generating a new chunk container and copying data chunks 322 not indicated as deleted from chunk container 304 into the new chunk container. The storage space may be reclaimed in the new chunk container by sequentially appending the non-deleted data chunks 322 in the new chunk container. The new chunk container may then be used in place of chunk container 304.

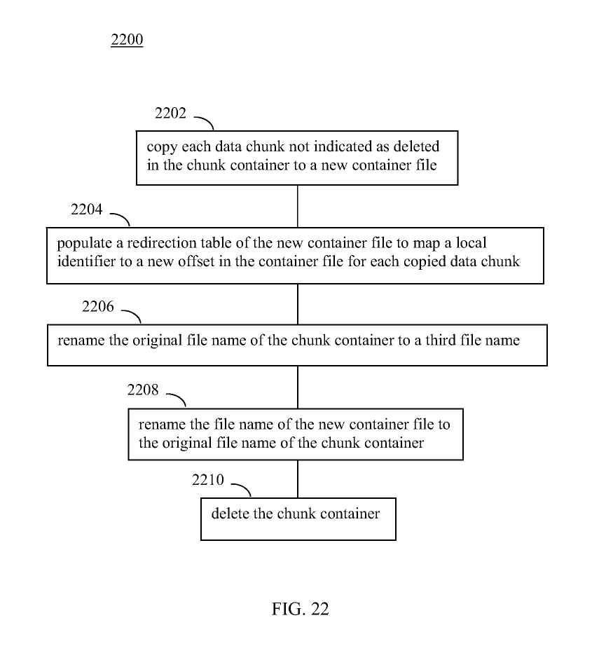

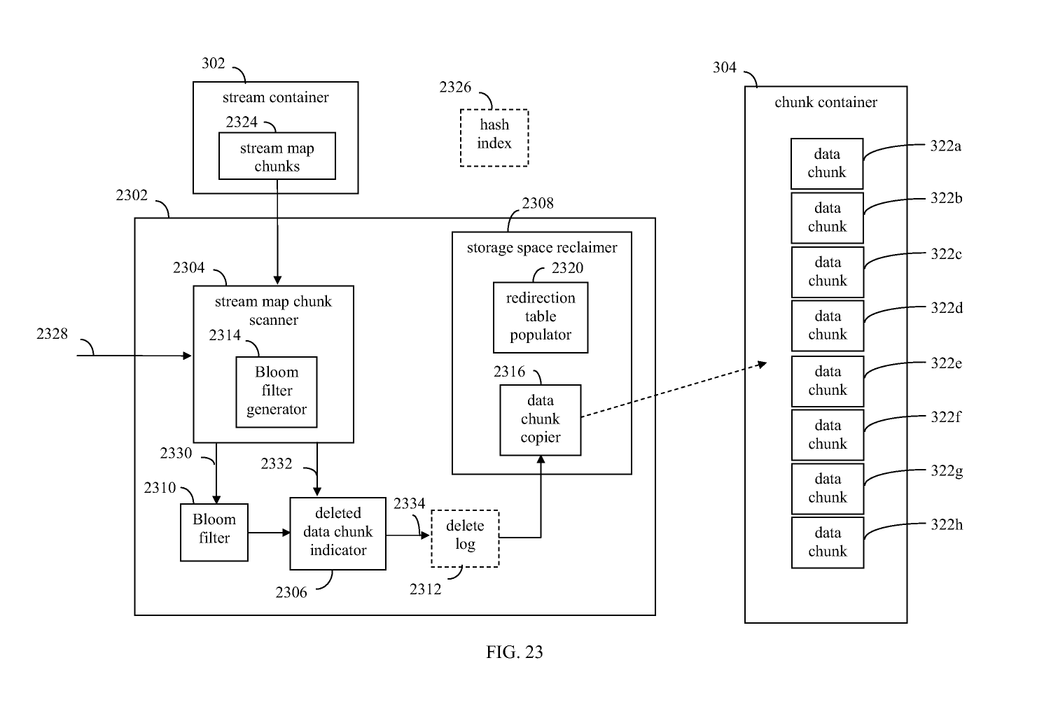

FIGS. 21 and 22 show flowcharts for performing flowchart 2000, according to example embodiments. For instance, FIG. 21 shows a flowchart 2100 for identifying and indicating data chunks for deletion (e.g., steps 2002 and 2004 of flowchart 2000), according to an example embodiment. Furthermore, FIG. 22 shows a flowchart 2200 for reclaiming storage space filled by the data chunks indicated for deletion (step 2006 of flowchart 2000), according to an example embodiment. For example, flowcharts 2100 and 2200 may be performed by chunk store interface 116. Flowcharts 2100 and 2200 are described as follows with reference to FIG. 23. FIG. 23 shows a block diagram of a garbage collection module 2302 that communicates with stream container 302 and chunk container 304 to reclaim storage space filled by deleted data chunks, according to an example embodiment. As shown in FIG. 23, garbage collection module 2302 includes a stream map chunk scanner 2304, a deleted data chunk indicator 2306, and a storage space reclaimer 2308. Further structural and operational embodiments will be apparent to persons skilled in the relevant art(s) based on the discussion regarding flowcharts 2100 and 2200. Flowchart 2100 is described as follows, followed by a description of flowchart 2200.

Flowchart 2100 begins with step 2102. In step 2102, a plurality of stream map chunks is scanned to determine any stream map chunks not indicated as deleted. For example, as shown in FIG. 23, stream map chunk scanner 2304 may receive a garbage collection initiation signal 2328 that indicates that garbage collection is to be performed by garbage collection module 2302. Signal 2328 may be generated periodically, when the storage space of chunk container 304 becomes filled to a predetermined amount or percentage, by user instruction, and/or in other manner. Upon initiation by signal 2328, stream map chunk scanner 2304 scans stream map chunks 2324 (e.g., stream maps 310a-310n shown in FIG. 3) to determine any of stream map chunks 2324 that are not indicated as deleted. For instance, stream map chunk scanner 2304 may perform a sequential scan of stream map chunks 2324 in each stream container 302. As described above, metadata 314 of stream map chunks 2324 may store a deletion indication when their respective data stream has been requested to be deleted. In another embodiment, stream map chunk scanner 2304 may scan one or more previously generated delete logs (e.g., as described below) that indicate deleted stream map chunks of stream container(s) 302 to determine stream map chunks 2324 that are not indicated as deleted. Thus, according to these embodiments, stream map chunk scanner 2304 may determine any stream map chunks of stream map chunks 2324 that do not include a deletion indication. The determined stream map chunks may be identified by stream map identifiers (data chunk identifiers for stream map chunks).

In step 2104, data chunk identifiers referenced by each stream map chunk indicated as not deleted are included in a Bloom filter. As described above in step 2104, stream map chunk scanner 2304 identified one or more of stream map chunks 2324 not indicated as deleted. Stream map chunk scanner 2304 may analyze each of the stream map chunks 2324 identified in step 2104 to determine the corresponding referenced data chunks (e.g., by data chunk identifiers). In an embodiment, stream map chunk scanner 2304 may use a data structure such as a Bloom filter to track the data chunks referenced by the identified stream map chunks 2324. As shown in FIG. 23, stream map chunk scanner 2304 may include a Bloom filter generator 2314. Bloom filter generator 2314 is configured to generate a Bloom filter 2310 that includes data chunk identifiers referenced by the stream map chunks indicated as not deleted. Although described herein a using a Bloom filter, in alternative embodiments, other data structures (e.g., hash tables, or similar structures/techniques) may be used instead of a Bloom filter to determined deleted stream maps.

A Bloom filter is a data structure well known to persons skilled in the relevant art(s). A Bloom filter is a compact set that may be used by program code to reliably determine if an item is not a member of a set. Bloom filters have a zero false negative rate and have a certain (small) percentage of false positive rate. In an embodiment, Bloom filter 2310 may be a bit array that is initially set to all zeros. To add an element to Bloom filter 2310 (e.g., a data chunk identifier for a particular data chunk), the element is fed to a set of k hash functions to generate k array positions. Each of the k array positions is set to 1 in Bloom filter 2310 to include the element in Bloom filter 2310. In alternative embodiments, a data structure (e.g., a table, a map, an array, etc.) other than a Bloom filter may be use to track the data chunks referenced by stream map chunks 2324 identified as not deleted.

In another embodiment, instead of using Bloom filter generator 2314 and Bloom filter 2310, other associative data structures may be used such as hash tables. An advantage of a Bloom filter is that a Bloom filter is more compact and is more memory efficient that most alternatives. A disadvantage of a Bloom filter relative to other data structures, such as hash tables, is that a Bloom filter can have a false positive and does not reclaim all unused space.

In step 2106, the plurality of stream map chunks is scanned to determine any stream map chunks indicated as deleted. For instance, stream map chunk scanner 2304 may scan stream map chunks 2324 to determine any of stream map chunks 2324 that are indicated as deleted. As described above, metadata 314 of stream map chunks 2324 may include a deletion indication when their respective data stream is requested to be deleted. Thus, stream map chunk scanner 2304 may determine any stream map chunks of stream map chunks 2324 that include a deletion indication. The determined stream map chunks may be identified by stream map identifiers (data chunk identifiers for stream map chunks). In another embodiment, stream map chunk scanner 2304 may scan one or more of the previously generated delete logs (e.g., as described below) that indicate deleted stream map chunks of stream container(s) 302 to determine stream map chunks 2324 that are indicated as deleted.

In step 2108, data chunk identifiers are determined that are referenced by the stream map chunks determined to be indicated as deleted and are not included in the Bloom filter. For instance, stream map chunk scanner 2304 may analyze each of the stream map chunks 2324 identified in step 2106 having a deletion indication to determine the referenced data chunks. As shown in FIG. 23, stream map chunk scanner 2304 outputs an identified data chunks indication 2332 that identifies the referenced data chunks (e.g., by data chunk identifiers). As shown in FIG. 23, deleted data chunk indicator 2306 receives Bloom filter 2310 and indication 2332. Deleted data chunk indicator 2306 applies the data chunk identifiers received in indication 2332 to Bloom filter 2310 to determine the data chunk identifiers that are not included Bloom filter 2310. As described above, a Bloom filter has no false negative. As such, if Bloom filter 2310 returns that a particular data chunk identifier is not found therein, this outcome is guaranteed to be correct. As such, if a data chunk identifier is not found in Bloom filter 2310, which tracks all non-deleted data chunks, then the data chunk identifier must be referenced only by deleted chunks, and therefore corresponds to an unused data chunk. In this manner, deleted data chunk indicator 2306 determines the data chunk identifiers that are referenced by stream map chunks 2324 determined to be indicated as deleted, and that are not included in Bloom filter 2310, to determine one or more unused data chunks (identified by data chunk identifier).

By arranging stream map chunks in one or more dedicated stream container(s), embodiments can scan all of them efficiently because the total size of all stream map chunks is much smaller compared to the total size of the original (un-optimized) data. The ratio is roughly the size of a stream map entry to the average size of a data chunk. In an embodiment with a 64 byte stream map entry size and a 64 KB average data chunk size, the ratio of total size of all stream map chunks versus a total size of the original data is 1 to 1000. Also, all stream map chunks can be scanned using mostly sequential I/Os. Note that the currently described technique for identifying unused data chunks does not assume how data chunks are stored in a chunk store. Data chunks can be stored in data container(s) as discussed herein, or can be stored in any other data structures. Furthermore, a count/list/table of references of data streams being maintained for each data chunk in a chunk store is not necessary. Furthermore, data chunk identifiers and stream map chunk identifiers can have any value that uniquely identifies the data chunks and stream map chunks, such as the structure of data chunk identifier 1300 shown in FIG. 13, an auto-incremented number, a randomly generated globally unique ID (GUID), etc. Also, the currently described technique specifies that each stream map entry 400 contains a data chunk identifier. The other fields (e.g. data stream offset, locality indicator) are optional.

In step 2110, the data chunks corresponding to the data chunk identifiers determined in step 2108 are indicated as deleted. As shown in FIG. 23, deleted data chunk indicator 2306 outputs a deleted data chunk indication 2334, which indicates the data chunks (by data chunk indicators) that are determined to be unused. In one embodiment, as shown in FIG. 23, deleted data chunk indicator 2306 may store deleted data chunk indication 2334 in a delete log 2312 for chunk container 304. Delete log 2312 stores the data chunk indicators received in indication 2334, which are the data chunk indicators for unused data chunks (that may be deleted from storage). In another embodiment (not shown in FIG. 23), deleted data chunk indicator 2306 may store a deletion indication in the metadata of each data chunk identified in deleted data chunk indication 2334. Updating data chunk record metadata in-place in this manner may add a reliability risk to the chunk store (e.g., if the system crashes in the middle of update). The use of delete log 2312 to track deleted data chunks may offer improved performance when a compaction stage (e.g., as described below with respect to flowchart 2200) scans deleted data chunks. However, either technique may be used.

Furthermore, as shown in FIG. 23, a hash index 2326 may be present. Hash index 2326 stores a plurality of entries that each map a data chunk identifier to a hash of its corresponding data chunk. Hash index 2326 may be referenced as desired to compare data chunks to determine whether they are duplicates of each other. For instance, if a newly received data chunk has a hash value that matches a hash value of a data chunk already stored in chunk container 304, the new and already stored data chunks are duplicates. In an embodiment, an entry may be deleted from hash index 2326 (e.g., by deleted data chunk indicator 2306) for each data chunk indicated as deleted in deleted data chunk indication 2334. By deleting these entries, hash index 2326 is maintained in sync with chunk container 304 (assuming that the data chunks indicated as deleted in deleted data chunk indication 2334 are eventually deleted).

Thus, according to flowchart 2100, unused data chunks are determined and are indicated as deleted. Subsequently, the storage space filled by the unused data chunks may be reclaimed and chunk container 304 may be compacted. For instance, flowchart 2200 may be performed to reclaim the storage space. Note that reclamation according to flowchart 2200 may be performed immediately after performing flowchart 2100 or at a later time. For instance, flowchart 2200 may be performed if a number of data chunks indicated as deleted (e.g., in delete log 2312, in data chunk metadata, etc.) is greater than a predetermined threshold (e.g., 20% or other percentage of a total chunk container size). If the number of data chunks indicated as deleted is below the threshold, storage reclamation/compaction of chunk container 304 may be postponed or not performed. The use of such a predetermined threshold may prevent a reclamation procedure from being performed that uses system resources with relatively little storage space reclamation gain.

Note that other techniques may be used to determine unused data chunks. For example, flowchart 2100 may be modified in one or more ways. For instance, in step 2102 of flowchart 2100, one or more delete logs may be scanned to determine any stream map chunks not indicated as deleted. In step 2104, data chunk identifiers referenced by each stream map chunk indicated as not deleted may be included in a Bloom filter. Next, a deletion bitmap may be generated that indicates a plurality of stream map chunks of one or more stream containers 302 being processed, that indicates the stream map chunks indicated as not deleted (as determined in step 2102), and indicates any other stream map chunks of the stream container(s) 302 as deleted. The delete log(s) may then be deleted. As an alternative to step 2106, the deletion bitmap may be scanned to determine any stream map chunks indicated as deleted. In step 2110, any data chunk identifiers referenced by the stream map chunks determined to be indicated as deleted (as determined in step 2106) that are not included in the Bloom filter may be indicated as deleted. One example advantage of this alternative embodiment is that the delete bitmap is a very compact structure that may be used to describe the deleted and non-deleted states of containers, and may do so more efficiently than delete logs. Furthermore, the delete logs become unneeded, and may be deleted earlier than in prior techniques.

As shown in FIG. 22, flowchart 2200 starts with step 2202. In step 2202, each data chunk in the chunk container not indicated as deleted is copied to a new container file. For instance, as shown in FIG. 23, storage space reclaimer 2308 includes a data chunk copier 2316, and a redirection table populator 2120. In an embodiment, data chunk copier 2316 copies each data chunk 322 in chunk container 304 that is not indicated as deleted to a new container file (for a new chunk container). For instance, as shown in FIG. 23, data chunk copier 2316 may receive delete log 2312, which includes data chunk identifiers for data chunks indicated for deletion. Data chunk copier 2316 may copy each data chunk 322 that does not have a data chunk identifier in delete log 2312 to the new chunk container. In another embodiment, where data chunks 322 in chunk container 304 may store deletion indications in their metadata, data chunk copier 2316 may analyze the metadata of each data chunk 322 in chunk container 304, and may copy to the new chunk container each data chunk 322 that does not have the deletion indication in their metadata.

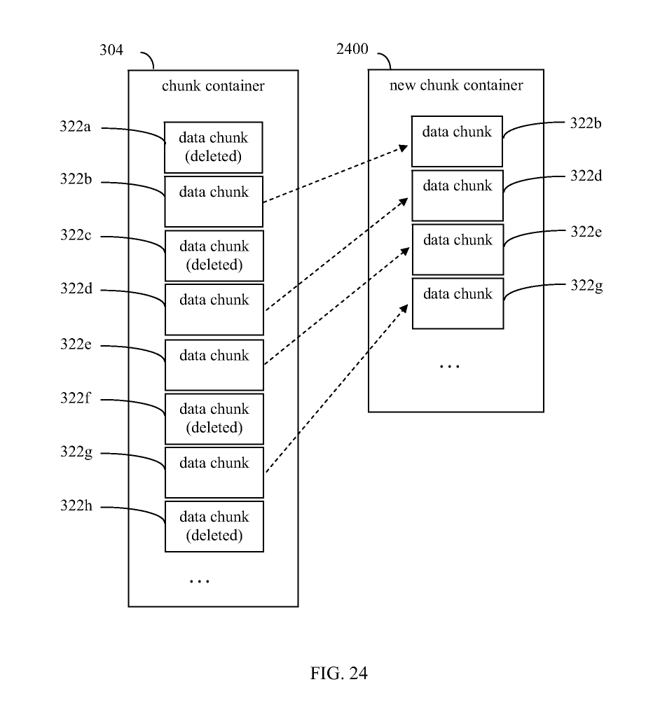

FIG. 24 shows a block diagram of an example of data chunks being copied from chunk container 304 (e.g., a first or original chunk container) to a new chunk container 2400 (e.g., as second chunk container), according to an embodiment. In the example of FIG. 24, data chunks 322a, 322c, 322f, and 322h are indicated for deletion (e.g., in delete log 2312 and/or in their own metadata), and data chunks 322b, 322d, 322e, and 322g are not indicated for deletion. Although data chunks 322a, 322c, 322f, and 322h are indicated for deletion, they are still present in chunk container 304. As such, data chunk copier 2316 is configured to generate a new container file for new chunk container 2400, and to copy data chunks 322b, 322d, 322e, and 322g not indicated for deletion to the new container file of new chunk container 2400. For instance, data chunk copier 2316 may sequentially copy data chunks 322b, 322d, 322e, and 322g to new chunk container 2400 to keep their order the same as was in chunk container 304. Furthermore, data chunk copier 2316 may copy data chunks 322b, 322d, 322e, and 322g into new chunk container 2400 to be adjacently positioned to each other, so that unused storage space is not present between data chunks 322b, 322d, 322e, and 322g, creating a compacted new chunk container 2400.

In step 2204, a redirection table of the new container file is populated to map a local identifier to a new offset in the container file for each copied data chunk. For example, in an embodiment, redirection table populator 2120 may be configured to populate a redirection table for the new chunk container that is similar to redirection table 1500 of FIG. 15. The redirection table for the new chunk container enables data access to data chunks stored in the new chunk container in a similar manner as described above with respect to redirection table 1500. Similarly to FIG. 15, redirection table populator 2120 may be configured to populate a redirection table for the new chunk container to include an entry for each copied data chunk. Each entry for a data chunk may include the local identifier 1304 for the data chunk and the chunk offset value 1308 for the data chunk in the new chunk container. Additionally, the entry for a data chunk may include the chunk container generation value and chunk offset value 1308 for the data chunk in chunk container 304, to directly map the chunk container generation value and first offset value in chunk container 304 to the second offset value in the new chunk container.

For instance, with regard to the example of FIG. 24, the redirection table populated by redirection table populator 2120 is populated with four new entries corresponding to data chunks 322b, 322d, 322e, and 322g copied to new chunk container 2400 (and potentially more entries corresponding to additional data chunks copied from chunk container 304 to new chunk container 2400). Each entry maps the local identifier for a data chunk 322 to the corresponding chunk offset value in new chunk container 2400.

At this point, optionally, the new container file (e.g., new chunk container 2400), which may each reside in cache memory, may be flushed from the cache memory, and stored in storage. Examples of such memory and storage are described elsewhere herein.

Although not shown in FIG. 22, flowchart 2200 may optionally include another step where at least one entry of the hash index is modified by replacing the data chunk identifier in the hash entry with the new data chunk identifier obtained from the merge log for the corresponding data chunk. In an embodiment, storage space reclaimer 2308 may include a hash index updater module that is configured to update hash index 2326 to point to the copied data chunks in the new chunk container. For instance, for each copied data chunk, storage space reclaimer 2308 may scan a redirection table to obtain a new chunk identifier and chunk header for the hash value of the copied data chunk. Storage space reclaimer 2308 may look up the hash value in hash index 2326 (a data chunk hash value typically is the key in a hash index) to locate an entry or record in hash index 2326 for the copied data chunk. Storage space reclaimer 2308 may modify the record to point to the new data chunk location in the new chunk container by replacing the existing data chunk indicator in the record with the new data chunk indicator for the copied data chunk.

Referring back to flowchart 2300, storage space reclaimer 2308 may rename the file name of the new chunk container to the file name of chunk container 304 to replace chunk container 304 with the new chunk container. For instance, in step 2206, the original file name of the chunk container is renamed to a third file name. Referring to FIG. 24, a file name of chunk container 304 may be renamed to a third (e.g., a dummy or temporary) file name. In step 2208, the file name of the new container file is renamed to the original file name of the chunk container. Referring to FIG. 24, the file name of new chunk container 2400 may be renamed to the file name of chunk container 304 (the file name prior to its renaming in step 2206). In step 2210, the chunk container is deleted. Referring to FIG. 24, chunk container 304 renamed to the third file name may be deleted. As such, new chunk container 2400 replaces chunk container 304.

At this point, new chunk container 2400, which replaces chunk container 304, is compacted and any unused storage space is reclaimed. Flowcharts 2100 and 2200 may be performed as often as desired to reclaim unused storage space.

In an embodiment, it may be desired to reduce a size of the redirection table of the new chunk container. For instance, in an embodiment, redirection tables of one or more chunk containers may be loaded, and a temporary index may be generated from the redirection tables that keys on the local identifier and the new data chunk identifiers. The stream maps of stream container(s) 302 may be enumerated, and the data chunks referenced by each stream map may be enumerated. The local identifier 1304 part of the data chunk identifiers may be looked up in the temporary index. If a match is found, the data chunk reference in the stream map may be updated with the new data chunk identifier.

Note that in one embodiment, the data chunk identifiers may be appended (e.g., replaced) in place in the stream map chunk in stream container 302. In another embodiment, (e.g., for improved reliability), a new stream container can be generated in a similar manner as described above for chunk containers, and a portion of flowchart 2200 may be followed (e.g., steps 2202, 2204, 2206, 2208, and 2210) to fill the new stream container with updated stream maps. In such an embodiment, stream map chunks are copied to the new stream container at the same offset as in the old stream container. Furthermore, there is no need to update the generation number of the stream map chunk identifiers. The stream container file can be compacted by performing flowchart 2200.

### E. Example Embodiments for Providing Hotspot Relief

Some data chunks are repeated over and over (e.g., thousands of times) in the namespace of optimized data. In other words, some data chunks stored in a chunk store may be referenced by thousands of data streams (e.g., files), or even larger numbers of data streams. If one of these highly referenced data chunks, also referred to herein as “hotspots,” is lost (e.g., is corrupted in storage), thousands of data streams may be lost, which is a reliability concern for data storage systems. Embodiments are described in this subsection for providing data chunk redundancy for hotspot relief, where backup copies are automatically made and stored for frequently referenced data chunks (“hotspots”). As a result, if a frequently referenced data chunk is corrupted in the chunk store, the corruption may be detected, and the backup copy of the data chunk may be used. Additionally, if the backup copy is corrupted, the original copy of the data could be used to restore the backup copy. Even further, other techniques could be employed to implement a reliable store of the metadata, such as N-way replication (replicating data chunks in more than two copies), erasure coding techniques, etc.

Many currently used techniques for improving storage reliability limit the number of references that may be made to unique data chunks. For instance, according to one technique, a count of the total number of references to each data chunk in a chunk store is maintained. When the total number of references to a particular data chunk exceeds a threshold value, a backup copy of the data chunk is made. However, maintaining a reference count (or reference list, or reference table) for data chunks is inefficient with regard to machine resources. This is because the reference count is updated every time a non-unique data chunk is received as part of a new data stream to be stored, and whenever the data chunk is deleted (e.g., whenever a data stream that refers to the data chunk is deleted).

As such, in embodiments, data chunks that are most used (chunks with the highest reference counts) are identified and mirrored (a second copy is created) such that in the event of a corruption (a bad storage sector, etc.), the second copy may be used when the data chunk is accessed. In this manner, the exposure to damaged data streams is reduced in the event of a corrupted data chunk. Embodiments scale with an increasing amount of stored data, consume little in terms of machine resources, and do not necessitate a reference count for each data chunk to be maintained, which assists a chunk store in scaling and being resource-efficient.

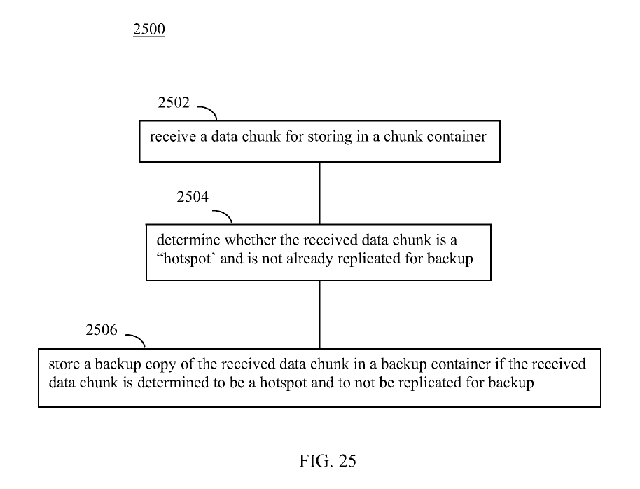

In an embodiment, the providing of redundant data chunks to improve storage reliability may be performed by identifying data chunks that are in a top percentage (e.g., 1%, etc.) of most referenced data chunks and/or that have a number of references greater than a threshold value, and generating backup copies of the identified data chunks. The backup copies may be stored in a backup chunk container or other storage location. For instance, FIG. 25 shows a flowchart 2500 for backing up data chunks for a chunk container, according to an example embodiment. Flowchart 2500 may be performed by chunk store interface 116 of FIG. 1, in an embodiment. Further structural and operational embodiments will be apparent to persons skilled in the relevant art(s) based on the discussion regarding flowchart 2500. Flowchart 2500 is described as follows.

In step 2502 of flowchart 2500, a data chunk is received for storing in a chunk container. For example, with reference to FIG. 1, chunk store interface 116 may receive a data chunk for storage in a chunk container of chunk store 118.

In step 2504, whether the received data chunk is a “hotspot,” (a highly referenced data chunk) and is not already replicated for backup is determined. A hotspot data chunk may be defined a data chunk included in a predetermined top percentage of most referenced data chunks in all present chunk containers, or having a number of references greater than a predetermined reference threshold, or both. In an embodiment, chunk store interface 116 may be configured to determine whether the received data chunk is a highly referenced data chunk that may be desired to be stored in a backup container, and is not already stored in a backup container. In an embodiment, the criteria for a highly referenced data chunk that may be desired to be stored in a backup container include the data chunk being in a predetermined top percentage of most referenced data chunks in all present chunk containers, and/or having a number of references greater than a predetermined reference threshold. For instance, the data chunk may be determined to be highly referenced if the data chunk is classified in the top 1%, 5%, 10%, or other top percentage of the data chunks stored in all present chunk containers in terms of being the most referenced. Additionally or alternatively, the data chunk may be determined to be highly referenced if the data chunk has a number of references (by stream maps) that is greater than a predetermined threshold, such as 10 references, 50 references, 100 references, or other threshold number of references.

In step 2506, a backup copy of the received data chunk is stored in a backup container if the received data chunk is determined to be a hotspot and to not be replicated for backup. If the received data chunk is determined to be highly referenced, the data chunk may be copied, and the copy of the data chunk may be stored in backup storage, such as a backup chunk container. The copy of the data chunk in the backup storage may be used if the first, primary copy of the data chunk becomes lost or otherwise corrupted.

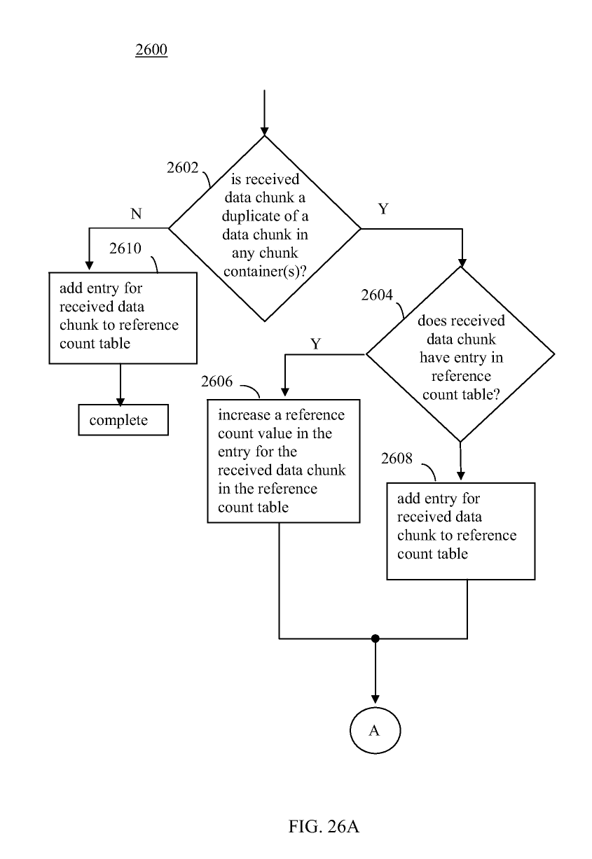

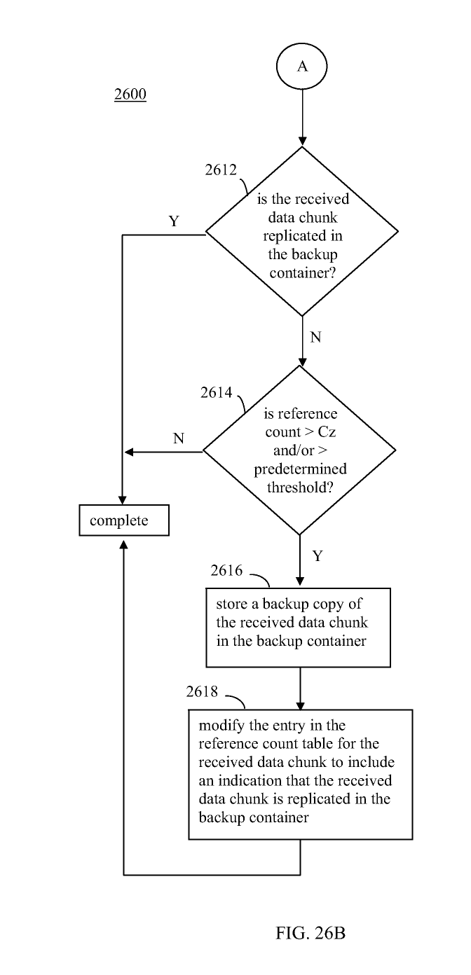

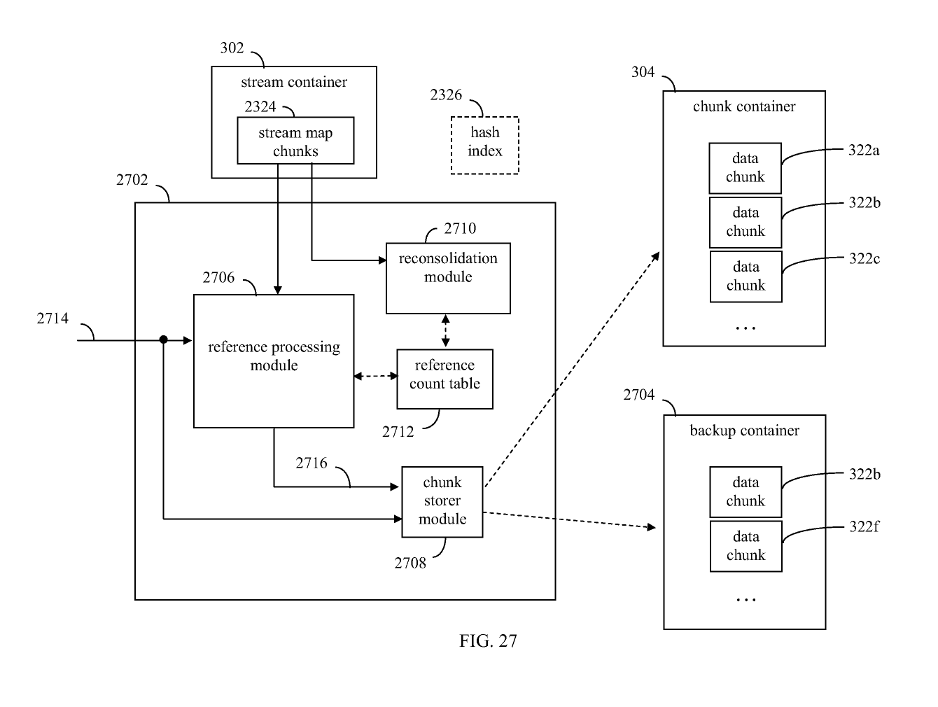

FIGS. 26A and 26B show a process for performing flowchart 2500, according to an example embodiment. For instance, FIGS. 26A and 26B show a flowchart 2600 for backing up highly referenced data chunks, according to an example embodiment. In an embodiment, flowchart 2600 may be performed by chunk store interface 116. Flowchart 2600 is described as follows with reference to FIG. 27. FIG. 27 shows a block diagram of a backup storage module 2702 that communicates with stream container 302, chunk container 304, and a backup container 2704 to backup frequently referenced data chunks, according to an example embodiment. As shown in FIG. 27, backup storage module 2702 includes a reference processing module 2706, a chunk storer module 2708, and a reconsolidation module 2710. For ease of illustration a single chunk container 304 is shown in FIG. 27. However, in embodiments, any number of chunk containers may be present in the chunk store containing chunk container 304 of FIG. 27, and all present chunk containers may be handled along with chunk container 304. Furthermore, in embodiments, any number of backup containers 2704 may be present. Furthermore, in embodiments, any number of stream containers 302 may be present. Further structural and operational embodiments will be apparent to persons skilled in the relevant art(s) based on the discussion regarding flowchart 2600. Flowchart 2600 is described as follows.

As shown in FIG. 26A, flowchart 2600 begins with step 2602. In step 2602, whether the received data chunk is a duplicate of a data chunk stored in any chunk container(s) is determined. For instance, as shown in FIG. 27, reference processing module 2706 receives a received data chunk 2714. Data chunk 2714 is a data chunk received for storage in chunk container 304. For instance, data chunk 2714 may be one data chunk of a plurality of data chunks of a data stream to be stored. Because chunk container 304 is included in a chunk store that stores data chunks in a de-duplicated fashion, reference processing module 2706 determines whether received data chunk 2714 is a duplicate of a data chunk 322 that is already stored in chunk container 304. For instance, data chunk 2714 may be received in a storage request that indicates whether or not data chunk 2714 is already stored in a chunk container, and reference processing module 2706 may determine whether data chunk 2714 has a duplicate stored in chunk container 304 based on the storage request. Alternatively, reference processing module 2706 may determine whether data chunk 2714 has a duplicate stored in chunk container 304 by generating a hash of data chunk 2714, and comparing the generated hash to the hashes stored in hash index 2326 (when hash index 2326 is present). Hash index 2326 stores hashes for each of data chunks 322 stored in chunk container 304, and therefore if the hash of data chunk 2714 matches a hash in hash index 2326, data chunk 2714 is a duplicate of a data chunk stored in chunk container 304. If data chunk 2714 is a duplicate, operation in flowchart 2600 proceeds to step 2604. If data chunk 2714 is not a duplicate of a data chunk stored in chunk container 304, operation in flowchart 2600 proceeds to step 2610. Note that step 2602 is optional. In embodiments, step 2602 may be skipped, and operation may proceed to step 2604 instead.

In step 2604, whether the received data chunk has an entry in a reference count table is determined. For example, as shown in FIG. 27, a reference count table 2712 is present. Reference count table 2712 may be maintained in memory. Reference count table 2712 is configured to store entries for a portion of data chunks 322 stored in any chunk containers 304 of the chunk store. The number of entries in a reference count table is at least the same as the number of hotspots in all chunk containers. The number of hotspots depends on various criteria and the original data size. For example, if a hotspot data chunk is defined as a data chunk being referenced 100 times or more, the maximum number of hotspots is the original data size divided by 100 and then divided by the average data chunk size. If a hotspot chunk is defined as the top 1% of most referenced chunks, the maximum number of hotspots is the number of unique data chunks in all chunk containers divided by 100. To reduce the number of reconsolidations (e.g., as described below), in an embodiment, the reference count table may be set to size to be a few times the estimated number of hotspots in all chunk containers. For instance, if a hotspot chunk is defined as the top 1% of most referenced chunks, reference count table 2712 may maintain entries for about 2% of data chunks 322 of all chunk containers 304 of the chunk store. A portion of reference count table 2712 maintains entries for a currently tracked/known predetermined top percentage (e.g., 1%) of the highly referenced data chunks 322, with each entry including a reference count. The remaining portion of reference count table 2712 is used to track either an exact reference count of received data chunks or an estimated reference count of some received data chunks. As such, reference count table 2712 tracks reference counts for a portion of the total number of data chunks 322 of chunk container 304, in contrast to some currently used techniques that track reference counts for all stored data chunks.

In an embodiment, each entry or record of reference count table 2712 may include the following fields (in any order) for a corresponding tracked data chunk 322:
First field: data chunk identifier (e.g., data chunk identifier 1300 of FIG. 13),
Second field: a reference count (e.g., either an exact count value or an expected count value),
Third field: an indication whether the reference count is an exact value (e.g., true/false), and
Fourth field: an indication whether the data chunk is replicated (e.g., true/false).
   Only the first, second and forth fields need to be present, while the third field is optional. Without the third field, all the reference counts are assumed to be non-exact. Note that a data chunk identifier can be any value that uniquely identifies a data chunk or a stream map chunk, such as the structure of data chunk identifier 1300 shown in FIG. 13, an auto-incremented number, a randomly generated globally unique ID (GUID), etc. Reference processing module 2706 may determine whether received data chunk 2714 has an entry in reference count table 2712 by comparing the data chunk identifier for data chunk 2714 (e.g., received with data chunk 2714, obtained from hash index 2326, etc.) with the data chunk identifiers of the entries in reference count table 2712, and if a match occurs, an entry for data chunk 2714 is present.

If received data chunk 2714 has an entry in reference count table 2712, operation proceeds from step 2604 to step 2606. If received data chunk 2714 does not have an entry in reference count table 2712, operation proceeds from step 2604 to step 2608.

In step 2606, a reference count value is increased in the entry for the received data chunk in the reference count table. In the case of step 2606, where data chunk 2714 is a duplicate of a data chunk 322 in chunk container 304, and an entry in reference count table 2712 exists for data chunk 2714, the reference count in the entry for data chunk 2714 in reference count table 2712 is increased by reference processing module 2706, or may be modified in other ways in embodiments other than being incremented. For instance, the reference count may be incremented by one to indicate that an additional reference to data chunk 2714 (stored in chunk container 304) was received (e.g., by a new data stream being stored that includes received data chunk 2714). Operation proceeds from step 2606 in FIG. 26A to step 2612 in FIG. 26B.

In step 2608, an entry for the received data chunk is added to the reference count table. In the case of step 2608, where data chunk 2714 is a duplicate of a data chunk 322 in chunk container(s) 304 if step 2602 is not skipped (or may or may not be a duplicate of a data chunk 322 in chunk container(s) if step 2602 is skipped), and an entry in reference count table 2712 does not exist for data chunk 2714, a new entry for data chunk 2714 is added to reference count table 2712 by reference processing module 2706. In this case, although data chunk 2714 is a duplicate, data chunk 2714 does not have enough references to be considered a highly referenced data chunk, as evidenced by data chunk 2714 not having an entry in reference count table 2712. The new entry for data chunk 2714 added to reference count table 2712 includes the data chunk identifier for data chunk 2714, a reference count value for data chunk 2714 that is a sum of an initial reference count value (e.g., a reference count value of one) and an expected count value (e.g., “Ce”), an indication that the reference count value for data chunk 2714 is not an exact value, and an indication that data chunk 2714 is not replicated in backup container 2704.

If step 2602 is not skipped, the expected count value, Ce, is an expected reference count value used for new entries to reference count table 2712 for data chunks that have duplicates stored in chunk container 304. Because the data chunk have duplicates already stored in chunk container 304, their exact reference count value is not known, and therefore expected count value, Ce, is used to provide an estimated reference count value. A value for expected count value, Ce, may be selected on an application-by-application basis. An upper bound for expected count value, Ce, may be a maximum reference count among the data chunks discarded from reference count table 2712 (e.g., “Cd”). In an embodiment, expected count value, Ce, may be set to 1 to avoid replicating data chunks unnecessarily. If step 2602 is skipped, the lower bound of Ce is zero, instead of 1. Operation proceeds from step 2608 in FIG. 26A to step 2612 in FIG. 26B.

In step 2610, an entry for the received data chunk is added to the reference count table. In the case of step 2610, where data chunk 2714 is not a duplicate of a data chunk 322 in chunk container 304, and therefore is a new data chunk to chunk container 304, an entry for data chunk will not be present in reference count table 2712. As such, an entry for data chunk 2714 may be added to reference count table 2712 by reference processing module 2706. The entry for data chunk 2714 includes the data chunk identifier for data chunk 2714, an initial reference count value for the received data chunk (e.g., a reference count value of 1), an indication that the reference count value for data chunk 2714 is an exact value, and an indication that data chunk 2714 is not replicated in backup container 2704. After adding the new entry for data chunk 2714 according to step 2610, processing of data chunk 2714 is complete.

For example, with reference to chunk container 304 and backup container 2704 shown in FIG. 27, reference count table 2712 may include the example information shown in Table 1 below (provided for purposes of illustration):

| data chunk | | reference count | data chunk |
|---|---|---|---|
| identifier | reference count | exact value? | replicated? |
| identifier for | 15 | True | True |
| data chunk | | | |
| 322b | | | |
| identifier for | 1 | True | False |
| data chunk | | | |
| 322h | | | |
| identifier for | 2 | False | False |
| data chunk | | | |
| 322c | | | |
| . . . | . . . | . . . | . . . |

With regard to the first entry in Table 1, data chunk 2714 may have been received as a duplicate of data chunk 322b, and an entry for data chunk 2714/322b may have already existed in Table 1. In such case, step 2606 of flowchart 2600 may have been performed, increasing the reference count value for data chunk 2714/322b to 15 from 14. As shown in the entry for data chunk 2714/322b, the reference count value is indicated as exact, and data chunk 2714/322b is indicated as replicated in backup container 2704.

With regard to the second entry in Table 1, data chunk 2714 may have been received as a new data chunk to chunk container 304, and stored in chunk container 304 as data chunk 322h. In such case, step 2610 of flowchart 2600 may have been performed, adding an entry for data chunk 2714/322h to Table 1. As shown in Table 1, the new entry for data chunk 2714/322h includes the data chunk identifier for data chunk 322h, an initial reference count value of 1, an indication that the reference count value is exact, and an indication data chunk 2714/322h is not replicated in backup container 2704.

With regard to the third entry in Table 1, data chunk 2714 may have been received as a duplicate of data chunk 322c, and an entry for data chunk 2714/322b may not have existed in Table 1. In such case, step 2608 of flowchart 2600 may have been performed, adding an entry for data chunk 2714/322c to Table 1. As shown in Table 1, the new entry for data chunk 2714/322c includes the data chunk identifier for data chunk 322c, an initial reference count value of 1 summed with an example expected count value of 1 (for a sum of 2), an indication that the reference count value is not exact, and an indication data chunk 2714/322h is not replicated in backup container 2704.

In step 2612, whether the received data chunk is replicated in the backup container is determined. For example, referring to FIG. 27, reference processing module 2706 may determine whether data chunk 2714 is replicated in backup container 2704. Reference processing module 2706 may make the determination in various ways. For instance, if data chunk 2714 is determined to not be a duplicate of a data chunk 322 of chunk container 304 in step 2602, or to not have an entry in reference count table 2712 in step 2604, reference processing module 2706 may determine data chunk 2714 to not be replicated in backup container 2704. If an entry for data chunk 2714 is present in reference count table 2712, reference processing module 2706 may access the field of reference count table 2712 (e.g., the fourth field) indicating whether the data chunk is replicated to make the determination. If data chunk 2714 is determined to not be replicated in backup container 2704, operation proceeds from step 2612 to step 2614. If data chunk 2714 is determined to be replicated in backup container 2704, processing of data chunk 2714 is complete.

In step 2614, whether the received data chunk has a reference count value that is greater than a minimum reference count value for already replicated data chunks, and/or whether the reference count value of the received data chunk is greater than a predetermined threshold are determined. In an embodiment, a data chunk is considered to have a number of references in a top 1% or other top percentage of data chunks if the data chunk has a reference count that is greater than a minimum reference count, Cz, of the data chunks that are currently replicated in a backup container 2704. As such, reference processing module 2706 may be configured to compare the reference count value of data chunk 2714 (from the corresponding entry in reference count table 2712) with the minimum reference count, Cz.

In an embodiment, a predetermined threshold, Y, may be maintained that is a minimum threshold reference count value that data chunks have to exceed in order to be backup copied. Predetermined threshold, Y, may have any suitable value, such as 10 references, 20 references, or other value. As such, in an embodiment, reference processing module 2706 may be configured to also compare the reference count value of data chunk 2714 with the predetermined threshold, Y.

In an embodiment, if the reference count value of data chunk 2714 is greater than minimum reference count, Cz, and/or is greater than predetermined threshold, Y, operation proceeds from step 2614 to step 2616. If the reference count value of data chunk 2714 is less than minimum reference count, Cz, and/or is less than predetermined threshold, Y, processing of data chunk 2714 is complete.

In step 2616, a backup copy of the received data chunk is stored in the backup container. For example, as shown in FIG. 27, reference processing module 2706 may generate a store instruction 2716 that indicates a backup copy of data chunk 2714 should be stored. As shown in FIG. 27, chunk storer module 2708 receives store instruction 2716. Chunk storer module 2708 provides an interface for reference processing module 2706 with storage, such as chunk container 304 and backup container 2704. As shown in FIG. 27, chunk storer module 2708 receives data chunk 2714. As a result of the backup copy request included in store instruction 2716, chunk storer module 2708 stores data chunk 2714 in backup container 2704. Operation proceeds from step 2616 to step 2618.

Note that if data chunk 2714 is a new data chunk (a duplicate of data chunk 2714 is not already stored in chunk container 304) as determined in step 2602, reference processing module 2706 may generate store instruction 2716 to instruct chunk storer module 2708 to store data chunk 2714 in chunk container 304.

In step 2618, the entry in the reference count table for the received data chunk is modified to include an indication that the received data chunk is replicated in the backup container. Reference processing module 2706 may modify the entry for data chunk 2714 in reference count table 2712 (e.g., the fourth field) to indicate that data chunk 2714 is replicated in backup container 2704 (replicated in step 2616). Processing of data chunk 2714 is complete.

Flowchart 2600 may be repeated for any number of received data chunks. For instance, in an embodiment, flowchart 2600 may be repeated until reference count table 2712 is filled (e.g., reaches a predetermined size). At that point and/or at other checkpoint, reference count table 2712 may be reconsolidated to reduce its size, and to make sure that the most highly referenced data chunks (e.g., the top 1%) have entries maintained in reference count table 2712.

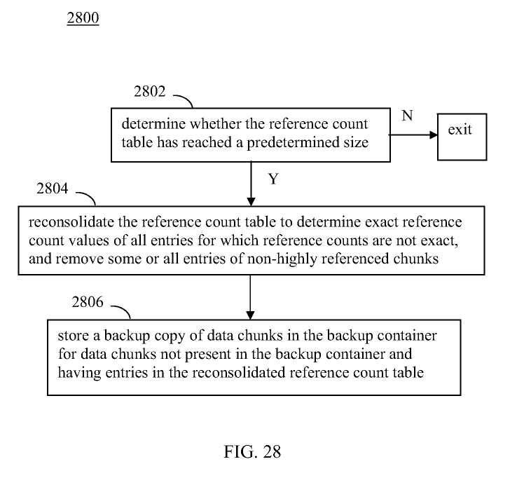

For instance, in an embodiment, a process shown in FIG. 28 may be performed. FIG. 28 shows a flowchart 2800 providing a process for reconsolidating a reference count table, according to an example embodiment. For instance, reconsolidation module 2710 shown in FIG. 27 may operate according to flowchart 2800. Flowchart 2800 is described as follows with reference to FIG. 27. Further structural and operational embodiments will be apparent to persons skilled in the relevant art(s) based on the discussion regarding flowchart 2800. Flowchart 2800 is described as follows.

As shown in FIG. 28, flowchart 2800 begins with step 2802. In step 2802, whether the reference count table has reached a predetermined size is determined. As described above, the size of a reference count table must be enough to store an entry for each hotspot in all chunk containers. The number of hotspots depends on the criteria and the original data size. To reduce a number of reconsolidations (as described below), embodiments may set the reference count table size to be a few times the estimated number of hotspots in all chunk containers. For example, in an embodiment, if a hotspot chunk is defined as the top 1% of most referenced chunks, the maximum number of hotspots is the number of data chunks in all chunk containers divided by 100 (i.e. 1% of all data chunks). Furthermore, if reconsolidation module 2710 expects chunk store to store 1 million data chunks in chunk container(s), it may determine a size of reference count table 2712 and may compare the determined size to a predetermined threshold size such as 2% of the total number of data chunks. The predetermined threshold size may be calculated to be 1 million data chunks×0.02=20,000 entries. Thus, in such an example, reconsolidation module 2710 may compare the determined size of reference count table 2712, in entries, to the predetermined threshold value of 20,000 entries. In other embodiments, the predetermined size may be determined in other ways.

If reference count table 2712 is determined to have reached the predetermined size, operation proceeds from step 2802 to step 2804. If reference count table 2712 is determined to have not reached the predetermined size, operation exits from flowchart 2800.

In step 2804, the reference count table is reconsolidated to determine exact reference count values of all entries for which reference counts are not exact. In an embodiment, reference count table 2712 may be reconsolidated by reconsolidation module 2710 to reduce its size by removing some or all entries which are not highly referenced data chunks. Operation proceeds from step 2804 to step 2806.

In step 2806, a backup copy of data chunks is stored in the backup container for data chunks not present in the backup container and having entries in the reconsolidated reference count table. In an embodiment, reconsolidation module 2710 may analyze the reconsolidated reference count table 2712 generated in step 2804. Reconsolidation module 2710 may store backup copies in backup container 2704 for any data chunks 322 having entries in the reconsolidated reference count table 2712 that do not have backup copies already stored in backup container 2704.

Furthermore, although not shown in FIG. 28, reconsolidation module 2710 may mark data chunks for deletion (e.g., store a deletion indication in the data chunk metadata, in a delete log such as delete log 2312 of FIG. 23, etc.) that no longer meet the replication criteria so that the marked data chunks are deleted from backup container 2704. Furthermore, a new value for the minimum reference count, Cz, of the data chunks that are currently already replicated in backup container 2704 may be determined by reconsolidation module 2710 at this point.

Note that the reconsolidation process of step 2804 of flowchart 2800 may be performed in various ways. According to the reconsolidation process, highly referenced data chunks/hotspots are intended to be included in reference count table 2712. However, the exact reference count value of some of the data chunks is not known because reference count table 2712 does not track reference count values for all data chunks 322. As such, during the reconsolidation process, the exact reference count values are determined. Furthermore, note that a data chunk may become a hotspot before reconsolidation, but the current technique may not detect the hotspot data chunk until reconsolidation. In some embodiments, it may be desired to replicate a data chunk as soon as it becomes a hotspot. This can be handled in various ways. In one embodiment, Ce is set to the maximum reference count of entries removed from reference count table in step 2804. Alternatively, if a hotspot chunk is defined as a data chunk that has a number of references (by stream maps) that is greater than a predetermined threshold, Ce can be set to 1, a backup copy may be created, and the data chunk may be maintained in the reference count table 2712 if the reference count reaches the predetermined threshold divided by 2.

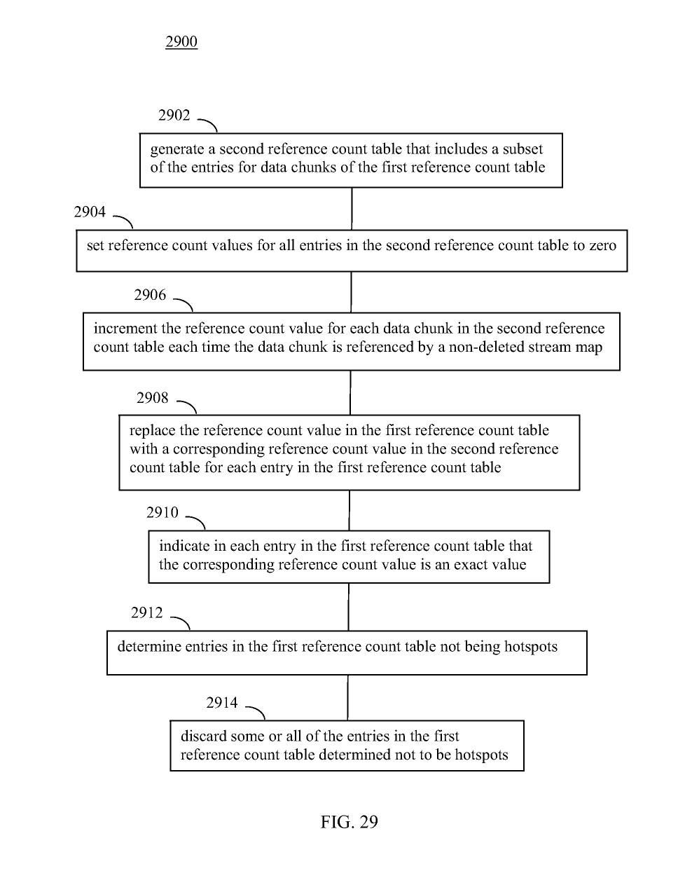

For instance, FIG. 29 shows a flowchart 2900 providing a reconsolidating process, according to an example embodiment. For instance, reconsolidation module 2710 shown in FIG. 27 may operate according to flowchart 2900 to reconsolidate reference count table 2712. Flowchart 2900 is described as follows with reference to FIG. 27. Further structural and operational embodiments will be apparent to persons skilled in the relevant art(s) based on the discussion regarding flowchart 2900. Flowchart 2900 is described as follows.

As shown in FIG. 29, flowchart 2900 begins with step 2902. In step 2902, a second reference count table is generated that includes a subset of the entries for data chunks of the first reference count table. For instance, a second reference count table (e.g., reference count table 2712b) may be generated by reconsolidation module 2710. The second reference count table includes the same fields as reference count table 2712, and includes a subset of the entries of reference count table 2712. The subset of entries includes entries for data chunks in reference count table 2712 that indicate that their reference count value is not an exact value (e.g., in their third field, described above). In embodiments, if step 2602 is skipped and the third field is omitted, the second reference count table may include all of the entries for data chunks of the first reference count table.

In step 2904, reference count values for all entries in the second reference count table are set to zero. For instance, reconsolidation module 2710 may set all of the reference count values (e.g., the second field) of the second reference count table to zero.

In step 2906, the reference count value for each data chunk in the second reference count table is incremented each time the data chunk is referenced by a non-deleted stream map. Reconsolidation module 2710 may scan stream map chunks 2324 of all stream containers 302 of the chunk store to determine which stream maps are not deleted (e.g., stream map chunks that do not include a deletion indication, that are not listed in a delete log, etc.). For the data chunks referenced by the stream map chunks determined to not be deleted, reconsolidation module 2710 may increment their reference count values (e.g., the second field) in the second reference count table. Each time a data chunk is referenced by a stream map chunk, the reference count value is incremented, so that the total number of references by stream maps to the data chunk is counted. By arranging stream map chunks in one or more dedicated stream container(s), in embodiments, they can all be scanned efficiently because the total size of all stream map chunks is much smaller compared to the total size of the original (un-optimized) data. This ratio is roughly the size of a stream map entry to the average size of a data chunk. In an embodiment with a 64 byte stream map entry size and a 64 KB average data chunk size, the ratio of a total size of all stream map chunks versus a total size of the original data is 1 to 1000. Also, all stream map chunks can be scanned using mostly sequential I/Os. Note that the current example does not assume how data chunks are stored in a chunk store. Data chunks may be stored in data container(s) as described above, or may be stored in any other data structure(s). A count/list/table of references of data streams being maintained for each data chunk in a chunk store is not needed to be maintained. Furthermore, data chunk identifiers and stream map chunks identifier can have any value that uniquely identifies the data chunks and stream map chunks, such as data chunk identifier 1300 in FIG. 13, an auto-incremented number, a randomly generated globally unique ID (GUID), etc. Also, this technique only utilizes data chunk identifiers of each stream map entry 400. The other fields, e.g., data stream offset and locality indicator, are optional.

In step 2908, the reference count value in the first reference count table is replaced with a corresponding reference count value in the second reference count table for each entry in the first reference count table. Reconsolidation module 2710 may copy the reference count values (e.g., the second field) from the second reference count table to the corresponding entries in reference count table 2712 to replace their reference count values.

In step 2910, the corresponding reference count value is indicated as an exact value in each entry in the first reference count table. Reconsolidation module 2710 may provide an indication in each entry of reference count table 2712 that the reference count is an exact value (e.g., may enter “true” into the third field of each entry).

In step 2912, entries in the first reference count table not being hotspots are determined. In an embodiment, reconsolidation module 2710 may compare the reference count values (e.g., the second field) of all the entries in reference count table 2712 to determine which entries have reference count values in the top predetermined percentage (e.g., 1%) and/or has a number of references greater than a predetermined reference threshold (e.g., 100). The determined entries correspond to hotspots, which are to have backup copies in backup container 2704. For instance, if any of these highly referenced data chunks do not have backup copies in backup container 2704, backup copies are made according to step 2806 (FIG. 28) as described above.

In step 2914, some or all of the entries in the first reference count table determined not to be hotspots may be discarded. Reconsolidation module 2710 may delete the entries from reference count table 2712 for each data chunk determined to not be highly referenced.

As such, backup copies of data chunks 322 considered to be highly referenced are stored in backup container 2704. These backup copies may be accessed in the event that the primary copies of the data chunks 322 in chunk container 304 are corrupted or otherwise lost (e.g., the specific data chunk is corrupted, chunk container 304 is lost or corrupted partially or in its entirety, etc.). For instance, in an embodiment, a chunk store may maintain a checksum of all data chunks in data chunk metadata stored in the respective stream map chunks 2324. When a request for a data chunk is received, and the data chunk is accessed in chunk store 118 by chunk store interface 116 of FIG. 1, chunk store interface 116 may calculate a checksum for the requested data chunk based on the version of the data chunk accessed in chunk container 304. If the calculated checksum does not match the stored checksum for the requested data chunk (e.g., stored in the data chunk metadata), a corruption of the data chunk in chunk container 304 is detected. If the corrupted data chunk has a backup copy in backup container 2704, chunk store interface 116 may access the backup copy in backup container 2704 and return the backup copy in response to the request. Furthermore, chunk store interface 116 may replace the corrupted data chunk in chunk container 304 with the backup copy of the requested data chunk stored in backup container 2704.

### III Example Computing Device Embodiments

Data deduplication module 104, maintenance module 106, data stream API 110, chunk maintenance API 112, data access API 114, chunk store interface 116, data stream parser 602, data chunk storage manager 604, metadata generator 606, stream map generator 608, metadata collector 802, locality indicator generator 804, rehydration module 1102, redirection table modifier 1702, generation incrementer 1704, data stream assembler 1902, generation checker 1906, data chunk retriever 1908, garbage collector module 2302, stream map chunk scanner 2304, deleted data chunk indicator 2306, storage space reclaimer 2308, Bloom filter generator 2314, data chunk copier 2316, merge log generator 2318, redirection table populator 2320, backup storage module 2702, reference processing module 2706, chunk storer module 2708, and reconsolidation module 2710 may be implemented in hardware, software, firmware, or any combination thereof. For example, data deduplication module 104, maintenance module 106, data stream API 110, chunk maintenance API 112, data access API 114, chunk store interface 116, data stream parser 602, data chunk storage manager 604, metadata generator 606, stream map generator 608, metadata collector 802, locality indicator generator 804, rehydration module 1102, redirection table modifier 1702, generation incrementer 1704, data stream assembler 1902, generation checker 1906, data chunk retriever 1908, garbage collector module 2302, stream map chunk scanner 2304, deleted data chunk indicator 2306, storage space reclaimer 2308, Bloom filter generator 2314, data chunk copier 2316, merge log generator 2318, redirection table populator 2320, backup storage module 2702, reference processing module 2706, chunk storer module 2708, and/or reconsolidation module 2710 may be implemented as computer program code configured to be executed in one or more processors. Alternatively, data deduplication module 104, maintenance module 106, data stream API 110, chunk maintenance API 112, data access API 114, chunk store interface 116, data stream parser 602, data chunk storage manager 604, metadata generator 606, stream map generator 608, metadata collector 802, locality indicator generator 804, rehydration module 1102, redirection table modifier 1702, generation incrementer 1704, data stream assembler 1902, generation checker 1906, data chunk retriever 1908, garbage collector module 2302, stream map chunk scanner 2304, deleted data chunk indicator 2306, storage space reclaimer 2308, Bloom filter generator 2314, data chunk copier 2316, merge log generator 2318, redirection table populator 2320, backup storage module 2702, reference processing module 2706, chunk storer module 2708, and/or reconsolidation module 2710 may be implemented as hardware logic/electrical circuitry.

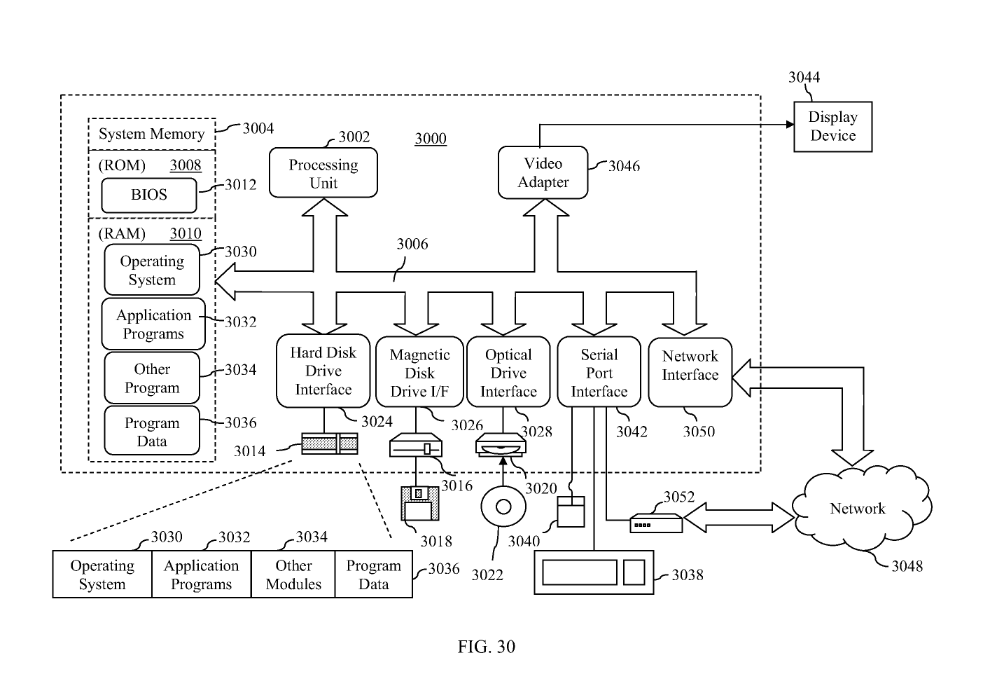

FIG. 30 depicts an exemplary implementation of a computer 3000 in which embodiments of the present invention may be implemented. For example, storage system 102, and/or any portion thereof, may be implemented in one or more computer systems similar to computer 3000, including one or more features of computer 3000 and/or alternative features. Computer 3000 may be a general-purpose computing device in the form of a conventional personal computer, a mobile computer, or a workstation, for example, or computer 3000 may be a special purpose computing device. The description of computer 3000 provided herein is provided for purposes of illustration, and is not intended to be limiting. Embodiments of the present invention may be implemented in further types of computer systems, as would be known to persons skilled in the relevant art(s).

As shown in FIG. 30, computer 3000 includes a processing unit 3002, a system memory 3004, and a bus 3006 that couples various system components including system memory 3004 to processing unit 3002. Bus 3006 represents one or more of any of several types of bus structures, including a memory bus or memory controller, a peripheral bus, an accelerated graphics port, and a processor or local bus using any of a variety of bus architectures. System memory 3004 includes read only memory (ROM) 3008 and random access memory (RAM) 3010. A basic input/output system 3012 (BIOS) is stored in ROM 3008.

Computer 3000 also has one or more of the following drives: a hard disk drive 3014 for reading from and writing to a hard disk, a magnetic disk drive 3016 for reading from or writing to a removable magnetic disk 3018, and an optical disk drive 3020 for reading from or writing to a removable optical disk 3022 such as a CD ROM, DVD ROM, or other optical media. Hard disk drive 3014, magnetic disk drive 3016, and optical disk drive 3020 are connected to bus 3006 by a hard disk drive interface 3024, a magnetic disk drive interface 3026, and an optical drive interface 3028, respectively. The drives and their associated computer-readable media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 3030, one or more application programs 3032, other program modules 3034, and program data 3036. Application programs 3032 or program modules 3034 may include, for example, computer program logic for implementing data deduplication module 104, maintenance module 106, data stream API 110, chunk maintenance API 112, data access API 114, chunk store interface 116, data stream parser 602, data chunk storage manager 604, metadata generator 606, stream map generator 608, metadata collector 802, locality indicator generator 804, rehydration module 1102, redirection table modifier 1702, generation incrementer 1704, data stream assembler 1902, generation checker 1906, data chunk retriever 1908, garbage collector module 2302, stream map chunk scanner 2304, deleted data chunk indicator 2306, storage space reclaimer 2308, Bloom filter generator 2314, data chunk copier 2316, merge log generator 2318, redirection table populator 2320, backup storage module 2702, reference processing module 2706, chunk storer module 2708, reconsolidation module 2710, flowchart 700, flowchart 900, flowchart 1600, flowchart 1800, flowchart 2000, flowchart 2100, flowchart 2200, flowchart 2500, flowchart 2600, flowchart 2800, flowchart 2900 (including any step of flowcharts 700, 900, 1600, 1800, 2000, 2100, 2200, 2500, 2600, 2800, and 2900), and/or further embodiments described herein.

A user may enter commands and information into the computer 3000 through input devices such as keyboard 3038 and pointing device 3040. Other input devices (not shown) may include a microphone, joystick, game pad, satellite dish, scanner, or the like. These and other input devices are often connected to the processing unit 3002 through a serial port interface 3042 that is coupled to bus 3006, but may be connected by other interfaces, such as a parallel port, game port, or a universal serial bus (USB).

A display device 3044 is also connected to bus 3006 via an interface, such as a video adapter 3046. In addition to the monitor, computer 3000 may include other peripheral output devices (not shown) such as speakers and printers.

Computer 3000 is connected to a network 3048 (e.g., the Internet) through an adaptor or network interface 3050, a modem 3052, or other means for establishing communications over the network. Modem 3052, which may be internal or external, is connected to bus 3006 via serial port interface 3042.

As used herein, the terms “computer program medium,” “computer-readable medium,” and “computer-readable storage medium” are used to generally refer to media such as the hard disk associated with hard disk drive 3014, removable magnetic disk 3018, removable optical disk 3022, as well as other media such as flash memory cards, digital video disks, random access memories (RAMs), read only memories (ROM), and the like. Such computer-readable storage media are distinguished from and non-overlapping with communication media. Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

As noted above, computer programs and modules (including application programs 3032 and other program modules 3034) may be stored on the hard disk, magnetic disk, optical disk, ROM, or RAM. Such computer programs may also be received via network interface 3050 or serial port interface 3042. Such computer programs, when executed or loaded by an application, enable computer 3000 to implement features of embodiments of the present invention discussed herein. Accordingly, such computer programs represent controllers of the computer 3000.

The invention is also directed to computer program products comprising software stored on any computer useable medium. Such software, when executed in one or more data processing devices, causes a data processing device(s) to operate as described herein. Embodiments of the present invention employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMs, nanotechnology-based storage devices, and the like.

### VI. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for garbage collecting a chunk store, the chunk store including data stored as a plurality of data chunks, the plurality of data chunks including stream map chunks, each stream map chunk corresponding to a stream map for a corresponding data stream and referencing data chunks stored in one or more chunk containers of the chunk store that are included in the corresponding data stream, the method comprising:
identifying data chunks stored in the one or more chunk containers that are unused based on being referenced only by stream map chunks indicated as deleted;
indicating the identified data chunks as deleted; and
reclaiming storage space in the one or more chunk containers containing the data chunks indicated as deleted.

2. The method of claim 1, wherein each stream map chunk references data chunks stored in the one or more chunk containers by corresponding data chunk identifiers, said identifying comprises:
scanning a plurality of stream map chunks to determine any stream map chunks not indicated as deleted;
including data chunk identifiers referenced by each stream map chunk indicated as not deleted in a data structure;
scanning the plurality of stream map chunks to determine any stream map chunks indicated as deleted; and
determining any data chunk identifiers referenced by the stream map chunks determined to be indicated as deleted that are not included in the data structure.

3. The method of claim 2, wherein said indicating comprises:
indicating as deleted the data chunks corresponding to the data chunk identifiers determined to be referenced by the stream map chunks indicated as deleted and that are not included in the data structure.

4. The method of claim 1, wherein each stream map chunk references data chunks stored in the one or more chunk containers by corresponding data chunk identifiers, said identifying comprises:
scanning at least one delete log to determine any stream map chunks not indicated as deleted;
including data chunk identifiers referenced by each stream map chunk indicated as not deleted in a data structure;
generating a deletion bitmap that indicates a plurality of stream map chunks of one or more stream containers, indicates the stream map chunks indicated as not deleted, and indicates other stream map chunks as deleted;
deleting the scanned at least one delete log;
scanning the deletion bitmap to determine any stream map chunks indicated as deleted; and
determining any data chunk identifiers referenced by the stream map chunks determined to be indicated as deleted that are not included in the data structure.

5. The method of claim 1, wherein said reclaiming comprises:
copying each data chunk not indicated as deleted in the chunk container to a new container; and
populating a redirection table of the new container to map a first chunk identifier in the chunk container to a second chunk identifier in the new container for each copied data chunk.

6. The method of claim 5, wherein the chunk store includes a hash index that stores a plurality of hash index entries, wherein each hash index entry of the hash index maps a data chunk identifier to a hash of a corresponding data chunk, wherein said reclaiming further comprises:
modifying at least one entry of the hash index by replacing the data chunk identifier in the hash entry with the new data chunk identifier obtained from the redirection table and chunk headers of the data chunks.

7. The method of claim 5, further comprising:
for each stream map chunk of the chunk store,
locating one or more referenced data chunks in one or more redirection tables of one or more chunk containers of the chunk store by corresponding data chunk identifiers stored in the stream map chunk for the referenced data chunks, and
appending the data chunk identifier in the stream map chunk for each of the one or more referenced data chunks located in the one or more redirection tables of the one or more chunk containers with the corresponding new data chunk identifier in the one or more redirection tables of the one or more chunk containers.

8. The method of claim 7, wherein said appending comprises:
appending data chunk identifiers in place in the stream map chunk in the chunk container.

9. The method of claim 7, wherein said appending comprises:
generating a second chunk container that includes the stream map chunk; and
appending data chunk identifiers in the stream map chunk in the second chunk container, the second chunk container being a stream map container.

10. A method for efficient data backup in a chunk store that stores a plurality of data streams in the form of data chunks, each data stream stored as a stream map that references data chunks of the data stream in a chunk container of the chunk store, the method comprising:
receiving a data chunk for storing in a chunk container;
determining whether the received data chunk is in a predetermined top percentage of most referenced data chunks in the chunk container, has a number of references greater than a predetermined heuristic that includes a predetermined reference threshold, and is not replicated for backup; and
storing a backup copy of the received data chunk in a backup container if the received data chunk is determined to be in the predetermined top percentage and/or to have a number of references greater than the predetermined reference threshold, and to not be replicated for backup.

11. The method of claim 10, wherein said determining comprises:
determining whether the received data chunk is a duplicate of a data chunk stored in the chunk container;
if the received data chunk is determined to be a duplicate, determining whether the received data chunk has an entry in a reference count table;
if the received data chunk is determined to be a duplicate and to have an entry in the reference count table, modifying a reference count value in the entry for the received data chunk in the reference count table; and
if the received data chunk is determined to be a duplicate and to not have an entry in the reference count table, adding an entry for the received data chunk to the reference count table that includes a data chunk identifier for the received data chunk, a reference count value for the received data chunk that is a sum of an initial reference count value and an expected count value, an indication that the reference count value for the received data chunk is not an exact value, and an indication that the received data chunk is not replicated in a backup container.

12. The method of claim 11, wherein said determining whether the received data chunk is in a predetermined top percentage of most referenced data chunks in the chunk container and/or has a number of references greater than a predetermined reference threshold further comprises:
adding an entry for the received data chunk to the reference count table if the received data chunk is determined to not be a duplicate, the entry for the received data chunk including a data chunk identifier for the received data chunk, an initial reference count value for the received data chunk, an indication that the reference count value for the received data chunk is an exact value, and an indication that the received data chunk is not replicated in the backup container.

13. The method of claim 11, wherein said determining whether the received data chunk is in a predetermined top percentage of most referenced data chunks in the chunk container and/or has a number of references greater than a predetermined reference threshold further comprises:
determining whether the received data chunk is replicated in the backup container; and
if the received data chunk is determined to not be replicated in the backup container,
determining whether the received data chunk has a reference count value that is greater than a minimum reference count value for already replicated data chunks, and/or
determining whether the reference count value of the received data chunk is greater than a predetermined threshold.

14. The method of claim 13, wherein said storing comprises:
if the received data chunk is determined to not be replicated in the backup container, is determined to have a reference count value that is greater than the minimum reference count value for already replicated data chunks, and/or to have a reference count value greater than the predetermined threshold,
storing a backup copy of the received data chunk in the backup container, and
modifying the entry in the reference count table for the received data chunk to include an indication that the received data chunk is replicated in the backup container.

15. The method of claim 14, further comprising:
determining that the reference count table has reached a predetermined size;
reconsolidating the reference count table to maintain entries for data chunks having reference count values in a top predetermined percentage and/or greater than the predetermined threshold; and
storing a backup copy of data chunks in the backup container for data chunks not present in the backup container and having entries in the reconsolidated reference count table.

16. The method of claim 15, wherein said reconsolidating comprises:
generating a second reference count table that includes a subset of the entries for data chunks of the first reference count table, the subset of entries including entries for data chunks in the first reference count table that indicate that the reference count value is not an exact value;
setting reference count values for all entries in the second reference count table to zero;
incrementing the reference count value for each data chunk in the second reference count table that is referenced by a non-deleted stream map;
replacing the reference count value in the first reference count table with a corresponding reference count value in the second reference count table for each entry in the first reference count table;
indicating in each entry in the first reference count table that the corresponding reference count value is an exact value;
determining entries in the first reference count table not having reference count values in the top predetermined percentage and/or greater than the predetermined threshold; and
discarding the entries in the first reference count table determined not to have reference count values in the top predetermined percentage and/or greater than the predetermined threshold.

17. A garbage collection module for garbage collecting a chunk store, the chunk store including data stored as a plurality of data chunks, the plurality of data chunks including stream map chunks, each stream map chunk corresponding to a stream map for a corresponding data stream and referencing data chunks stored in one or more chunk containers of the chunk store that are included in the corresponding data stream, the garbage collection module comprising:
a stream map chunk scanner configured to identify data chunks stored in the one or more chunk containers that are unused based on being referenced only by stream map chunks indicated as deleted;
a deleted data chunk indicator configured to indicate the identified data chunks as deleted; and
a storage space reclaimer configured to reclaim storage space in the one or more chunk containers containing the data chunks indicated as deleted.

18. The garbage collection module of claim 17, wherein each stream map chunk references data chunks stored in the one or more chunk containers by corresponding data chunk identifiers, wherein the stream map chunk scanner includes:
a Bloom filter generator configured to generate a Bloom filter;
wherein the stream map chunk scanner scans a plurality of stream map chunks to determine any stream map chunks not indicated as deleted, includes data chunk identifiers referenced by each stream map chunk indicated as not deleted in the Bloom filter, scans the plurality of stream map chunks to determine any stream map chunks indicated as deleted, and determines any data chunk identifiers referenced by the stream map chunks determined to be indicated as deleted that are not included in the Bloom filter.

19. The garbage collection module of claim 17, wherein the storage space reclaimer comprises:
a data chunk copier that copies each data chunk not indicated as deleted in the chunk container to a new container; and
a redirection table populator that populates a redirection table of the new container to map a first chunk identifier in the chunk container to a second chunk identifier in the new container for each copied data chunk.

20. The garbage collection module of claim 19, wherein the chunk store includes a hash index that stores a plurality of hash index entries, wherein each hash index entry of the hash index maps a data chunk identifier to a hash of a corresponding data chunk, wherein the storage space reclaimer modifies at least one entry of the hash index by replacing the data chunk identifier in the hash entry with the new data chunk identifier obtained from the redirection table and chunk headers of the data chunks.
